(19) United States
(12) Patent Application Publication
(10) Pub. No.: US 2008/0092130 A1
(43) Pub. Date: Apr. 17, 2008

(54) INFORMATION PROCESSING APPARATUS, DATA MANAGEMENT METHOD AND DATA MANAGEMENT PROGRAM

(76) Inventor: Shunichi MAEDA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/866,723

(22) Filed: Oct. 3, 2007

(30) Foreign Application Priority Data
Oct. 12, 2006 (JP) 2006-279106

(51) Int. Cl. G06F 9/44; G06F 17/30

(52) U.S. Cl. 717/168; 707/101

(57) ABSTRACT

An information processing apparatus capable of easily extending the data item of the data used by the software of the apparatus, and the data managing method and the data managing program for the apparatus are disclosed. The information processing apparatus includes one or more storage units storing data used by the software managed by the information processing apparatus; and a data managing unit, when a program capable of adding a function to the software is added, receiving knowledge/information of a data item required to execute the function from the program and extending the data item of data stored in the storage unit.

### BACKGROUND OF THE INVENTION

1. Field of the Invention

The present invention generally relates to an information processing apparatus, a data management method, and the data management program.

2. Description of the Related Art

Recently, image forming apparatuses including various devices such as a printer, a copy, a facsimile machine, and a scanner in one chassis (hereinafter referred to as “multifunctional product”) have come to be known. The multifunctional product is an example of an information processing apparatus.

The multifunctional product includes hardware for a display part, a printing part, an imaging unit, and the like in the chassis and software corresponding to the printer, facsimile machine, scanner, and the like, respectively. By switching the software, a function of the printer, copier, facsimile machine, scanner and the like is activated.

In a conventional multifunctional product, each function can be added by installing, for example, a plug-in component corresponding to the function (see, for example, Patent Document 1). When adding each function to the conventional multifunctional product, the data item of the data used by the adding function is added as shown in FIG. 1. The sequence diagram of FIG. 1 shows a typical procedure when the configuration of the multifunction product is as shown in FIG. 1.

FIG. 1 is a sequence diagram showing one example of the procedure when a FAX function is being added. When a FAX unit is attached to a multifunctional product, the multifunctional product detects the FAX unit as hardware. In step S1, the fact that the FAX unit is attached is transmitted to a FAX application 1. When the FAX application 1 is informed of the attachment of the FAX unit, the FAX application 1 sets the FAX function information declaring “function included” in setting information 2 in step S2. More specifically, the FAX application 1 sets the fact that the FAX function is enabled in the setting information 2, and the FAX function item in the setting information 2 is changed from “invalid” to “valid”.

In step S3, when the power is turned on, a UCS 3 sends a request to the setting information 2 to obtain the FAX function information. In step S4, the UCS 3 obtains the FAX function information from the setting information 2.

The UCS 3 checks the obtained FAX function information. When the FAX function item is “valid”, it falls into step S5 where the UCS 3 sends an instruction to a database (DB) 4 to add a data item of data (FAX information), used by the FAX function, to a user information table. The DB 4 adds the data item of the FAX information to the user information table.

### Patent Document 1: Japanese Patent Application publication NO.: 2003-333241

In a conventional multifunction product, there is the following problem in a function of extending the user information table when a data item is added to the user information table. First, all the functions regarding the extension of the user information table including a detailed specification defining how the extension is to be performed when a function of the multifunctional product is set to be valid is implemented into the UCS 3. Therefore, when the user information table is required to be extended in a conventional multifunctional product, it is necessary to modify the UCS 3.

Because of this feature, when a function of a component (for example, FAX application 1) using data is added and, to realize the function, a data item is required to be added to the current user information table, it is disadvantageously necessary to modify the UCS 3 as well as the component to add the function.

Furthermore, when new application software is created using an SDK (Software Development Kit) for a conventional multifunctional product, and even when it is necessary to add a data item to the user information table in the software, such a new data item cannot be added, since the UCS 3 cannot be modified.

### SUMMARY OF THE INVENTION

The present invention is made in light of the above-mentioned problems and may provide an information processing apparatus, a data managing method, and a data managing program in which a data item of the data used in software is easily extendable.

To solve the above-mentioned problems, according to one aspect of the present invention, there is provided an information processing apparatus including one or more storage units storing data used by the software managed by the information processing apparatus; and a data managing unit, when a program capable of adding a function to the software is added, receiving the knowledge/information of a data item required to execute the function from the program and extending the data item of the data stored in the storage unit.

According to another aspect of the present invention, there is provided a data management method employed in an image processing apparatus including one or more storage units storing data used by software managed by the information processing apparatus, the method including a receiving step of, when a program capable of adding a function to the software is added, receiving knowledge knowledge/information of a data item required to execute the function from the program; and an extending step of extending the data item of the data stored in the storage unit based on the knowledge/information.

According to still another aspect of the present invention, there is provided a data management program executed in an information processing apparatus including one or more storage units storing data used by the software managed by the information processing apparatus; a storage device including one or more types of storage media storing data of the one or more storage units; and a processing unit, in which the data management program causes the processing unit to work as a data managing unit, when a program capable of adding a function to the software is added, receiving knowledge/information of a data item required to execute the function from the program and extending the data item of the data stored in the storage unit.

It should be noted that any method, apparatus, system, computer program, recording medium, data structure or the like based on any variation, derivation, or combination from the description and drawings is included in the scope of the present invention.

According to an embodiment of the present invention, an information processing apparatus, a data managing method, and a data managing program in which a data item of the data used in software is easily extendable may be provided.

### BRIEF DESCRIPTION OF THE DRAWINGS

FIG. 1 is a sequence diagram showing an exemplary process when a FAX function is added;

FIG. 2 is a drawing showing an exemplary configuration of a multifunctional product according to one embodiment of the present invention;

FIG. 3 is a class diagram showing an outline of the present invention;

FIG. 4 is a class diagram when plural storage units are included;

FIG. 5 is an instance diagram expressed in instance derived from the class diagram of FIG. 3;

FIG. 6 is an image drawing showing a functional outline of the present invention when the FAX function is added;

FIG. 7 is a sequence diagram showing a process in a multifunctional product when the FAX function is added;

FIG. 8 is a flowchart showing a process of the data set management;

FIG. 9 is a flowchart showing a process of data set;

FIG. 10 is a flowchart showing a process of the data set that received an initialization request;

FIG. 11 is a flowchart showing a process of a multifunctional product when a ScanToE-mail function is added;

FIG. 12 is a sequence diagram showing a process of a multifunctional product when a document box function is added;

FIG. 13 is a sequence diagram showing a process of a multifunctional product when the FAX function is added and the table of a remote data server is being extended;

FIG. 14 is a class diagram showing a detail of the present invention;

FIG. 15 is a sequence diagram showing an exemplary process of data registration;

FIG. 16 is a sequence diagram shown an exemplary process of data search;

FIG. 17 is a class diagram showing a relationship between searching conditions and data search query;

FIG. 18 is a sequence diagram showing an exemplary process of data update;

FIG. 19 is a sequence diagram showing another exemplary process of data update;

FIG. 20 is a sequence diagram showing an exemplary process of data deletion;

FIG. 21 is a sequence diagram showing an example of an extension data display adding process;

FIG. 22 is a sequence diagram showing an example of an extension data display deleting process;

FIG. 23 is a sequence diagram showing an example of a storage data display adding process;

FIG. 24 is a sequence diagram showing an example of a storage data display deleting process;

FIG. 25 is a sequence diagram showing an example of a data set generating process;

FIG. 26 is a sequence diagram showing an example of a data set deleting process;

FIG. 27 is a flowchart showing an example of a data converting process from generic data to storage data;

FIG. 28 is a flowchart showing an example of a data converting process from generic data to extension data;

FIG. 29 is a flowchart showing an example of a data converting process from storage data to generic data;

FIG. 30 is a flowchart showing an example of a data converting process from extension data to generic data;

FIG. 31 is a flowchart showing an example of a data converting process from generic data to persistent data;

FIG. 32 is a flowchart showing an example of a data converting process from persistent data to generic data;

FIG. 33 is a block diagram showing a status of data conversion;

FIG. 34 is a schematic diagram showing a status of data conversion;

FIG. 35 is an object diagram showing a status of data conversion;

FIG. 36 is an object diagram showing the relationship between the application logic and various types of storage data;

FIG. 37 is another object diagram showing the relationship between the application logic and various types of storage data;

FIG. 38 is a schematic diagram of data registration; and

FIG. 39 is a schematic diagram of data acquisition.

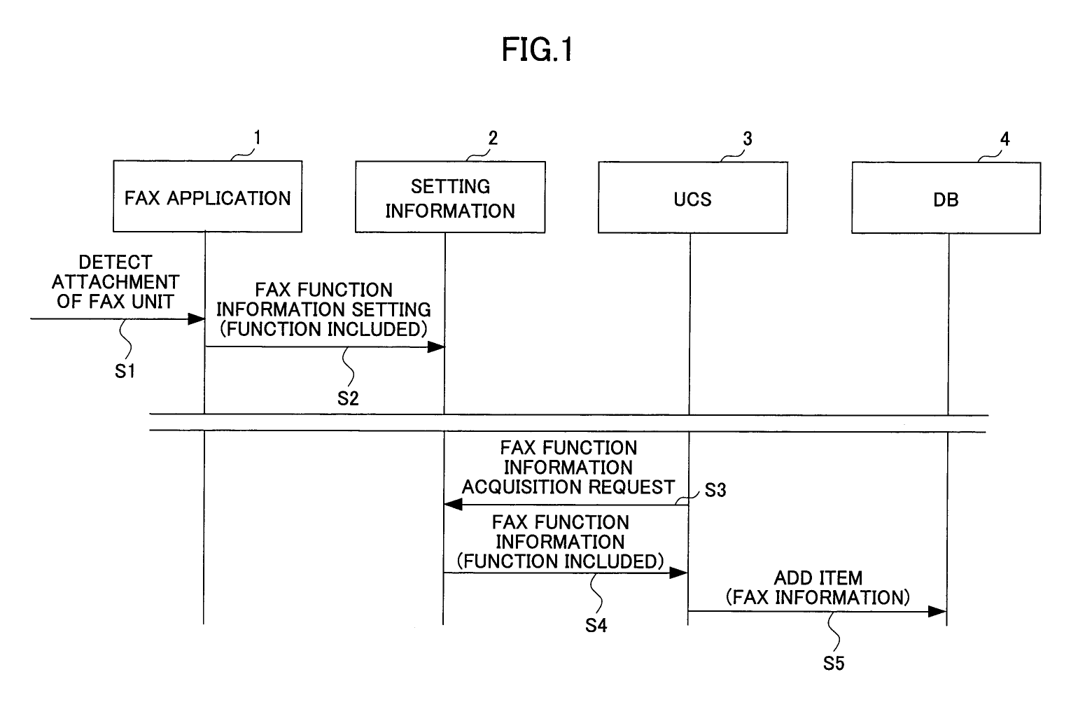

### DETAILED DESCRIPTION OF THE PREFERRED EMBODIMENTS

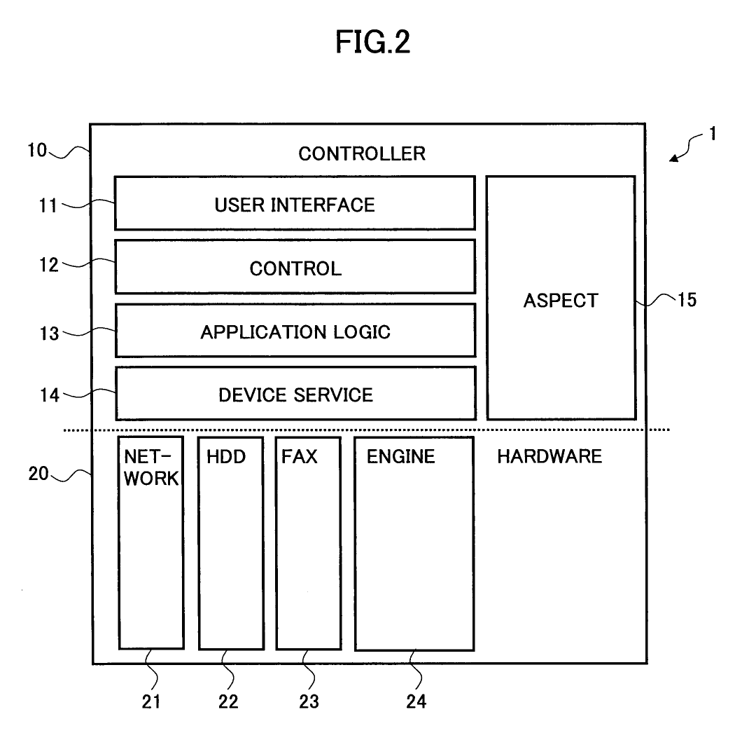

Next, exemplary embodiments of the present invention based on the following examples are described with reference to the accompanying drawings. The present invention is applicable to a multifunctional product having, for example, the configuration as shown in FIG. 2. It should be noted that the embodiments are described by referring to a multifunctional product as an example of an information processing apparatus for illustrative purposes only; therefore the present invention may also be applicable to other apparatuses or devices.

FIG. 2 shows an exemplary configuration of a multifunctional product according to an embodiment of the present invention. FIG. 2 shows a primary configuration including system architecture featuring controller software of the multifunctional product and the hardware configuration. In the following, the structure (including components) of the multifunctional product in FIG. 2 is described. The component is a group of design outlines at the logic level.

The multifunctional product in FIG. 2 includes a controller 10, and hardware 20. The controller 10 includes a user interface component 11, a control component 12, an application logic component 13, a device service component 14, and an aspect component 15. The hardware 20 in FIG. 2 includes a network device 21, a hard disk drive (HDD) device 22, a FAX device 23, and an engine device 24.

The user interface component (hereinafter “user interface”) 11 receives a request from a user or a service user (for example, a user of a Web service) and transfers the request to the control component (herein after “control”) 13 so that the request is fulfilled. The user interface 11 receives a user's operation via, for example, a user interface (UI).

The control 12 controls to combine functions so as to fulfill the request from the user interface 11. The control 12 controls, for example, a workflow. The application logic component (hereinafter “application logic”) 13 controls a group of functions provided by the multifunctional product. The application logic 13 controls a service provided by using the hardware 20.

Further, the device service component (hereinafter “device service”) 14 is a device source commonly used by the application logic 13. The aspect component (hereinafter “aspect”) 15 handles logic (for example, access control, recording, charging) cross-sectionally influencing each component. The aspect 15 manages data and processes.

The network device 21 provides an interface in contact with a network such as Ethernet™ and LAN. The HDD device 22 is a storage medium storing information. The FAX device 23 is an information transceiver (FAX) using a telephone line. The engine device 24 includes a forming device (plotter) outputting, for example, information onto a paper medium (printing medium).

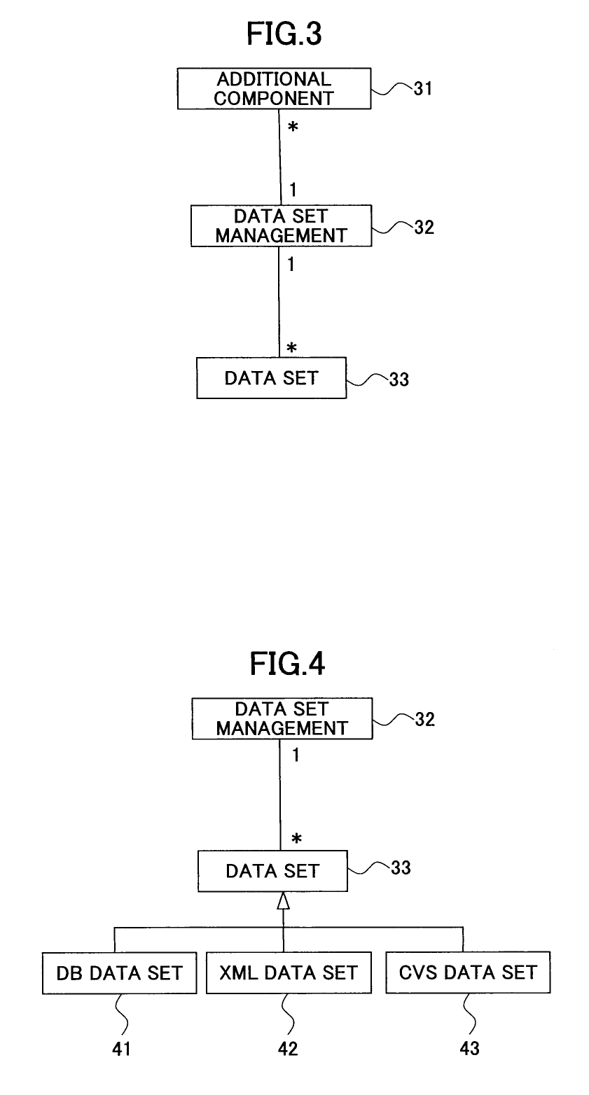

To facilitate understanding of the present invention, the outline of the present invention is described next. FIG. 3 is a class diagram illustrating the outline of an embodiment of the present invention. The class diagram of FIG. 3 shows a minimum configuration in the embodiment of the present invention. The parts described in the class diagram of FIG. 3 are an additional component class 31, a data set management class 32, and a data set class 33.

The additional component class (hereinafter simplified as “additional component”) 31 is a part where an extension function of the multifunctional product is implemented. The additional component 31 has the information required to extend a data table upon installation. The additional component 31 sends a request to the data set management class 32 to extend the data table when a component is initialized after the installation.

The data set management class (hereinafter simplified as “data set management”) 32 is a part uniformly managing the data set class 33. When a function is added, the data set management 32 receives the extension information and an extension request of the data set management from an additional component 31 such as a plug-in component. The data set management 32 searches for a data set class 33 to be an extension target and sends the extension information and a request for extending the data set to the searched for data set class 33. When no data set class 33 to be extended is found, the data set management 32 adds a new data set class 33 as a management target of the data set management.

The data set class (hereinafter simplified as “data set”) 33 has a part for each of the data set classes existing for each physical data storage unit such as a DB table, an XML file, and a CVS file. For example, the data set 33 becomes a unit such as a DB user information data set, a DB bibliographical information data set, and a CVS apparatus information data set.

The DB user information data set corresponds to the user information table of a database. The DB bibliographical information data set corresponds to the bibliographical information table of a database. The CVS apparatus information data set corresponds to the apparatus information table of CVS. The term “set” corresponds to the term “table” of RDB (Relational Data Base).

Such DB user information data set, DB bibliographical information data set, and CVS apparatus information data set may be expressed as the instances of data set class 33 or defined as the subclasses of the data set class 33.

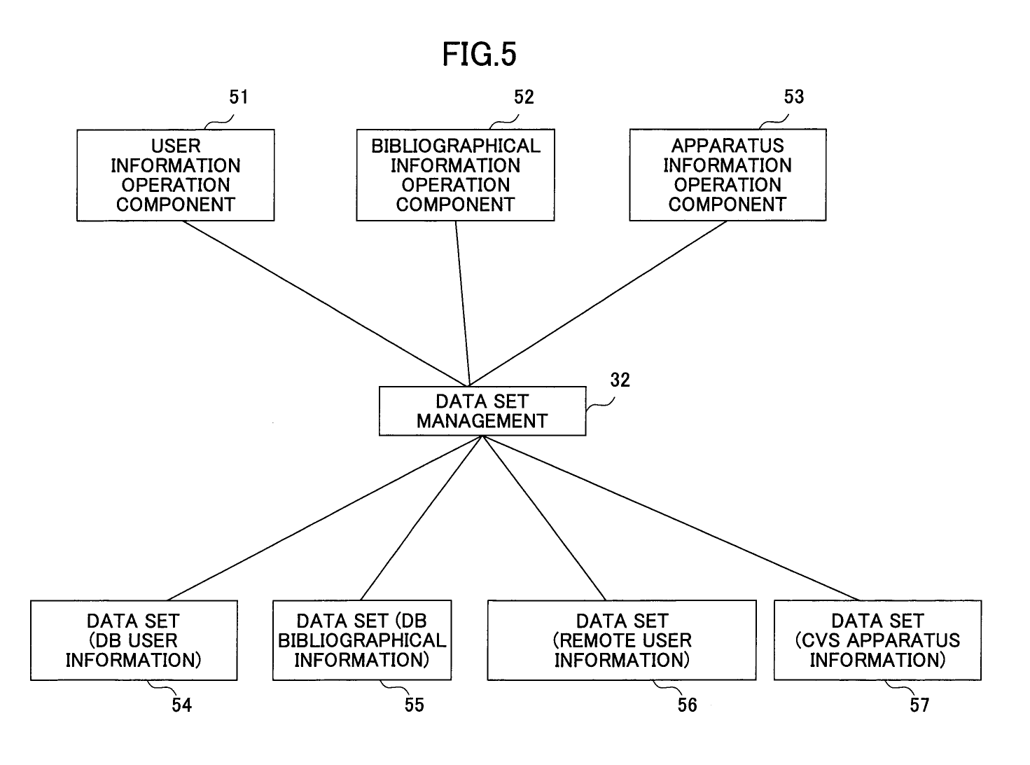

Further, when a multifunctional product has plural data storage units, the class diagram may be changed as shown in FIG. 4. FIG. 4 is a class diagram showing a configuration when the multifunctional product has plural data storage units. The parts shown in the class diagram of FIG. 4 are the data set management 32, the data set 33, a DB data set class 41, an XML data set class 42, and a CVS data set class 43. The additional component 31 is omitted in the class diagram of FIG. 4.

The DB data set class (hereinafter simplified as “DB data set”) 41 is a part in which the DB data set classes are provided for the corresponding DB tables as physical data storage units. The XML data set class (hereinafter simplified as “XML data set”) 42 is a part in which the XML data set classes are provided for the corresponding XML files as physical data storage unit. The CVS data set class (hereinafter simplified as “CVS data set”) 43 is a part in which the CVS set classes are provided for the corresponding CVS files as physical data storage units.

As the configuration as shown in FIG. 4, the DB user information data set, DB bibliographical information data set, and CVS apparatus information data set may be expressed as the instances of the DB data set 41, the XML data set 42, and the CVS data set 43, respectively, or may be defined as the subclasses of the DB data set 41, the XML data set 42, and the CVS data set 43, respectively.

The class diagram shown in FIG. 3 can be expressed in the instance diagram as shown in FIG. 5. Namely, FIG. 5 is an instance diagram when the class diagram of FIG. 3 is expressed using the corresponding instances. In the instance diagram of FIG. 5, the user information operation component, the bibliographical information operation component, the apparatus information operation component are expressed using the corresponding instances 51 through 53, respectively, of additional components 31 and the DB user information data set, the DB bibliographical information data set, the remote user information data set, and the CVS apparatus information data set are expressed using the instances 54 through 57, respectively, of the data sets 33.

Next, a more detailed outline of the embodiments of the present invention is described by referring to the cases of the additions of a FAX function, a ScanToE-mail function, and a document box function.

### (Addition of Fax Function)

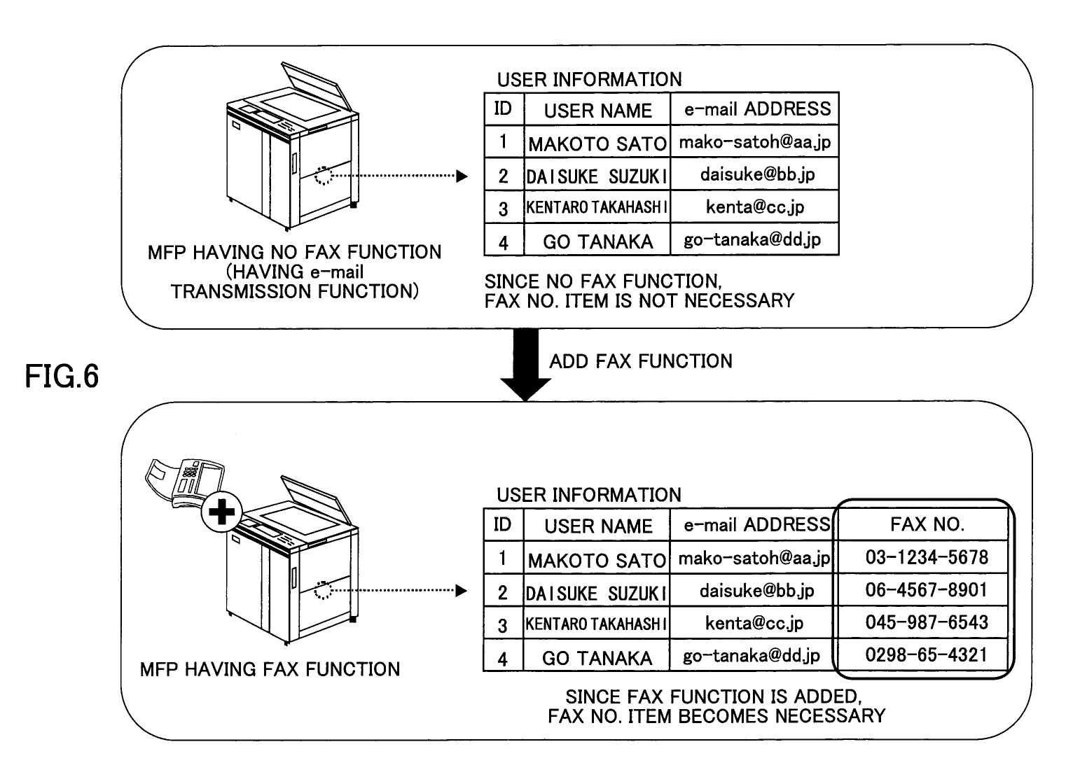

FIG. 6 shows an image illustrating a functional outline of an embodiment of the present invention when a FAX function is added. As shown in upper portion of FIG. 6, a multifunctional product (MFP) without a FAX function does not have to have the item for the FAX number as a data item in the user information. The user information shown in the upper portion of FIG. 6 shows a case of a multifunctional product having an e-mail transmission function. When a FAX function is added to the multifunctional product having the user information shown in upper portion of FIG. 6, the multifunctional product needs to have the item for the FAX number as a data item in the user information.

In the multifunctional product according to the embodiment of the present invention, the FAX function will be able to be used by installing a FAX plug-in component (hereinafter simplified as “FAX plug-in”) as one of the additional components 31. In such a case, the FAX information item (for example, a FAX No. item) necessary to realize the FAX function is added to the user information.

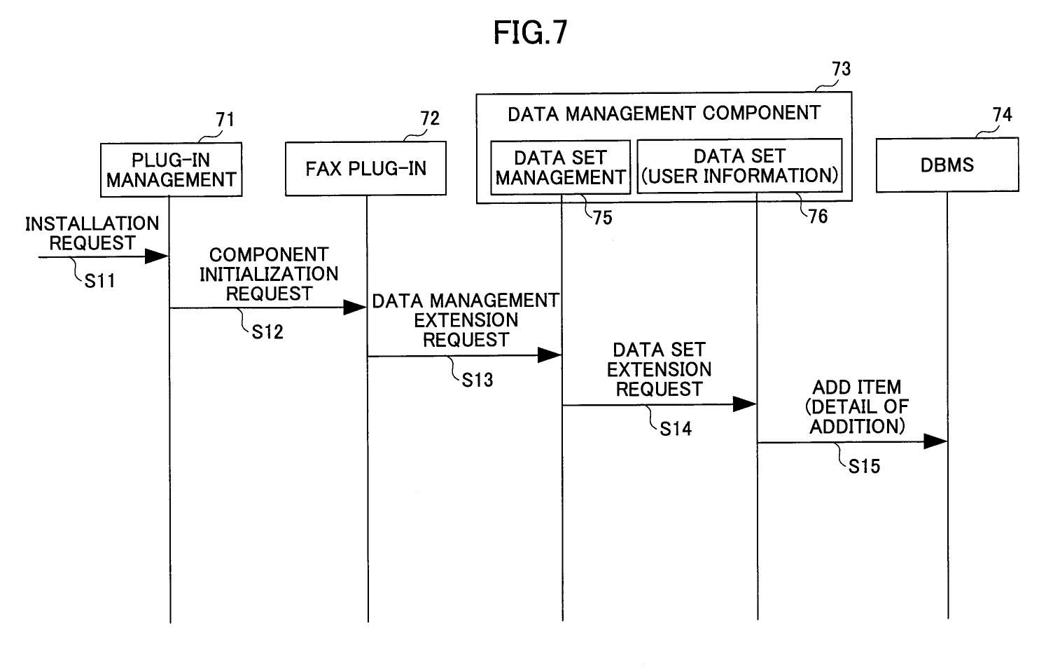

FIG. 7 is a sequence diagram showing a process of the multifunctional product when the FAX function is added to the multifunctional product. A plug-in management component (hereinafter simplified as “plug-in management”) 71 shown in FIG. 7 is included in the control 12 shown in FIG. 2. A FAX plug-in 72 is included in the application logic 13. A data management control 73 is included in the device service 14.

In step S11, when the plug-in management 71 receives an installation request of a FAX plug-in, the plug-in management 71 searches for the FAX plug-in as the target component of the search. In step S12, the plug-in management 71 sends a component initialization request to the target component.

When the FAX plug-in 72 receives the component initialization request, the FAX plug-in 72 configures the environment required to initiate the target component. The FAX plug-in 72 creates an extension rule of data management as one of the operations of configuring the environment.

In step S13, the FAX plug-in 72 transmits a usage data item and sends a data management extension request to the data management component 73. The usage data item refers to a data item that will be able to be used in the plug-in component after the corresponding function is installed. For example, for the usage data item when the FAX plug-in is installed, a usage data item name “FAX No. and user name” of the usage data set “user information” are added.

When a data set management 75 in the data management component 73 receives the data management extension request, the data set management 75 searches for the data set 76 managing the target table. For example, in the sequence diagram of FIG. 7, the DB user information data set is searched out. When the data set 76 is searched out, the data set management 75 sends an additional candidate data item and a data set extension request to the data set 76 in step S14. For example, when the FAX plug-in 72 is installed, the names of the additional candidate data items are “FAX No.” and “user name”.

When the data set 76 in the data management component 73 receives the data extension request, the data set 76 refers to the information, included in the received extension rule, necessary for adding a data item and sends data item addition detailed information and sends a data item adding request to the data base management system (hereinafter “DBMS”) 74.

For example, when the FAX plug-in 72 is added, the additional data items to be added includes “FAX destination” and its data item type is “character string”. The data set 76 checks and determines, for example, not to add the data item “user name” because the “user name” is already registered as a data item of the original user information.

When the DBMS 74 receives the data item adding request, the DBMS 74 adds the requested data item according to the data item adding request to the user information of the DB managed by the DBMS 74.

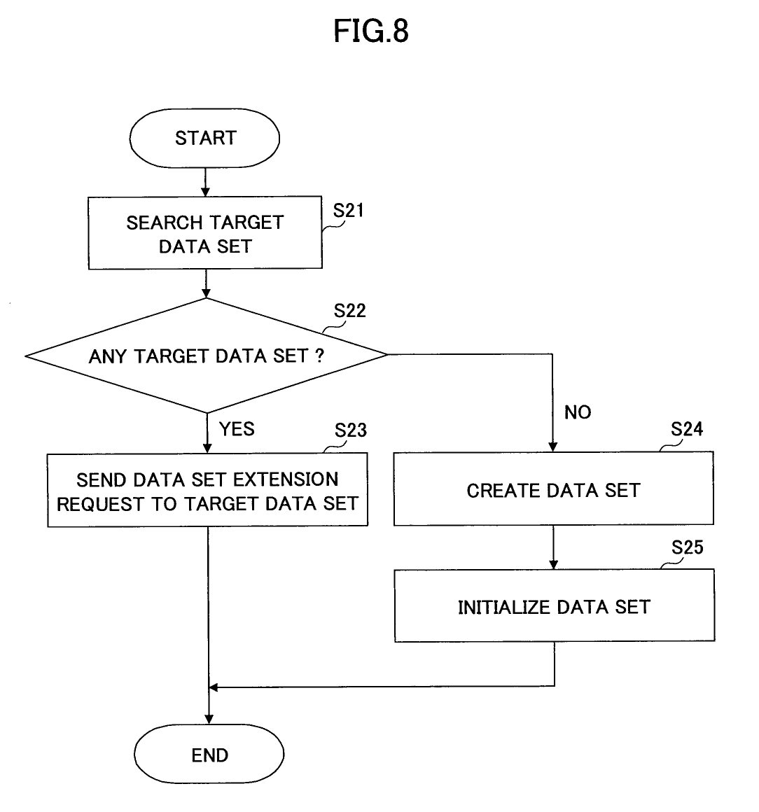

Further, a process of the data set management 75 shown in the sequence diagram of FIG. 7 is next described with reference to the flowchart of FIG. 8. FIG. 8 is a flowchart showing a process of the data set management.

When the data set management 75 receives the data management extension request, the data set management 75 searches for the data set (target data set) 76 in step S21. In step S22, the data set management 75 determines whether any target data set 76 exists.

When the target data set is searched out, the data set management 75 sends a data set extension request to the target data set 76 in step 23. In contrast, when no target data set 76 is searched out, the data set management 75 creates a data set in step S24. In step S25, the data set management 75 sends an initialization request to the data set 76 to initialize the created data set. A process of the data set 76 receiving the initialization request is described below.

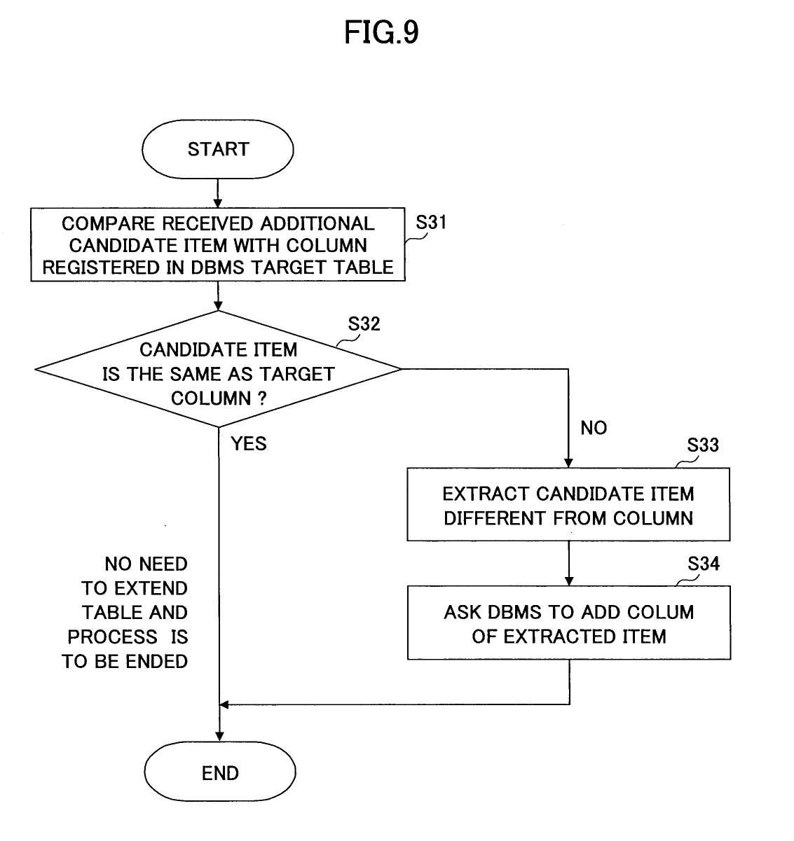

A process of the data set 76 shown in the sequence diagram of FIG. 7 is described with reference to the flowchart of FIG. 9. FIG. 9 is a flowchart showing a process of the data set.

When the data set 76 receives the data set extension request, the data set 76 compares the data of the received additional candidate data item with the data of the column registered in the table (target table) to be a target of the DBMS 74 in step S31.

In step S32, the data set 76 determines whether the data of the additional candidate data item is the same as the data of the column registered in the target table. When the data of the additional candidate data item is same as the data of the column registered in the target table, since the data set 76 does not have to extend the target table, the process of the flowchart in FIG. 9 is terminated.

In contrast, when the data of the additional candidate data item does is not same as the data of the column registered in the target table, in step S33, the data set 76 extracts the data of the additional candidate data item that is not same as the data of the column registered in the target table. In step S34, the data set 76 sends a data item adding request to the DBMS 74 to request the DBMS 74 to add the extracted data of the additional candidate data item to the column.

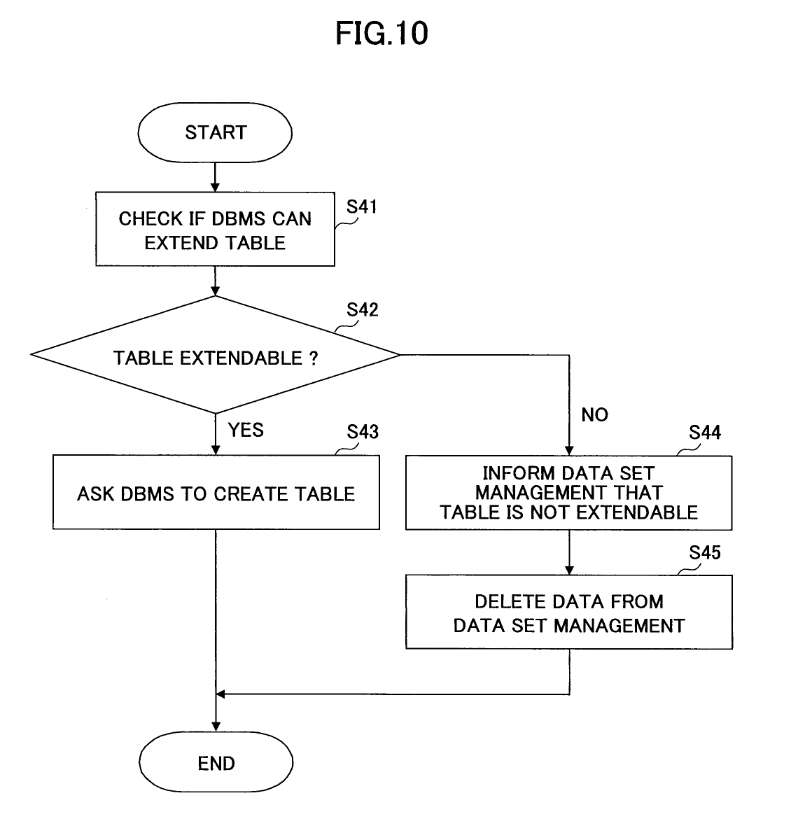

Now, a process of the data set 76 when the initialization request is received is described with reference to the flowchart of FIG. 10. FIG. 10 is a flowchart showing the process of the data set that received the initialization request.

In step S41, when the data set 76 receives the initialization request, the data set 76 checks whether the DBMS 74 can extend the table. In the checking whether the table is extendable, for example, the capacity of the HDD 22 is checked. When the table is extendable (YES at S42), the data set 76 requests the DBMS 74 to create a table in step S43.

In contrast, when the table is not extendable (NO at S42), the data set 76 informs the data set management 75 that the table is not extendable in step S44. In step S45, the data set 76 is deleted by the data set management 75.

As described above, the multifunctional product can add a FAX information item necessary to realize the FAX function when the FAX plug-in 72 is installed.

### (Addition of ScanToE-Mail Function)

In a multifunctional product according an embodiment of the present invention, a ScanToE-mail function will be able to be used by installing a ScanToE-mail plug-in component (hereinafter simplified as “ScanToE-mail plug-in”) as one of the additional components 31. In this case, a ScanToE-mail information item (for example, E-mail address item) necessary for realizing the ScanToE-mail function is added to the user information.

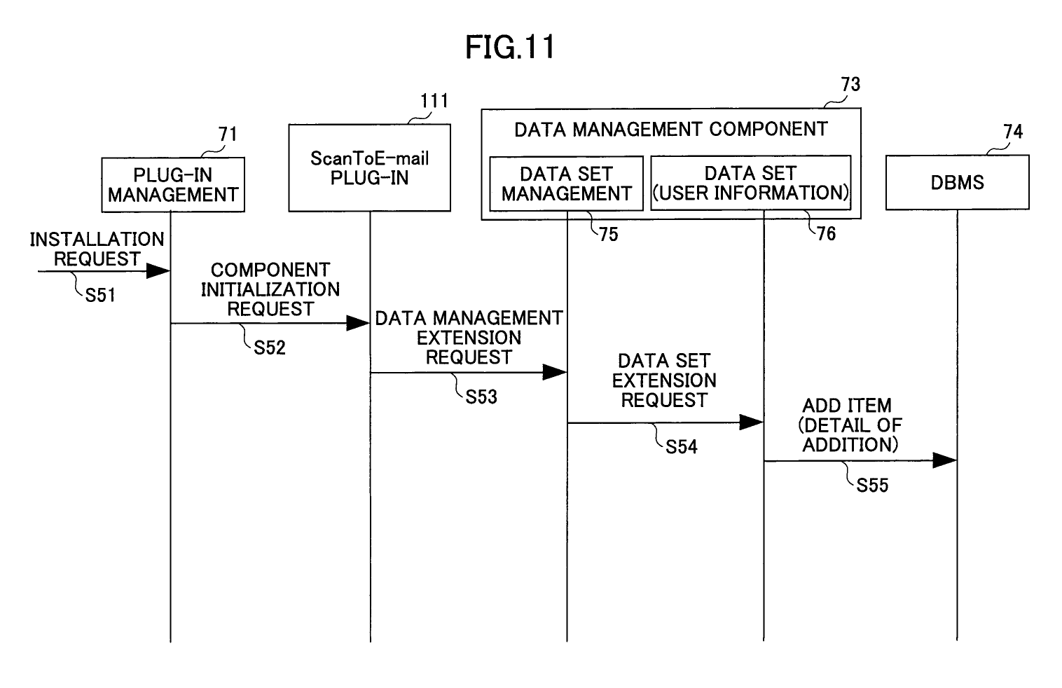

FIG. 11 is a sequence diagram showing a process of the multifunctional product when the ScanToE-mail function is added. A ScanToE-mail plug-in 111 shown in FIG. 11 is included in the application logic 12 shown in FIG. 2.

In step S51, when the plug-in management 71 receives the installation request of the ScanToE-mail plug-in, the plug-in management 71 searches for the ScanToE-mail plug-in 111 as the target component. In step S52, the plug-in management 71 sends a component initialization request to the target component.

When the ScanToE-mail plug-in 111 receives the component initialization request, the ScanToE-mail plug-in 111 configures the environment required to initiate the target component. The ScanToE-mail plug-in 111 creates an extension rule of the data management as one of the operations of configuring the environment.

In step S60, the ScanToE-mail plug-in 111 transmits the usage data item and a data management extension request to the data management component 73. When the ScanToE-mail plug-in 111 is added, the usage data items to be added are the usage data item names “e-mail address and the user name” of the usage data set “user information”.

When the data set management 75 in the data management component 73 receives the data management extension request, the data set management 75 searches for the data set 76 managing the target table. For example, in the sequence diagram of FIG. 11, the DB user information data set is searched out. When the data set 76 is searched out, the data set management 75 sends an additional candidate data item and a data set extension request to the data set 76 in step S54. For example, when the ScanToE-mail plug-in 111 is added, the names of additional candidate data items are “e-mail address, user name”.

When the data set 76 in the data management component 73 receives the data set extension request, the data set 76 refers to the information, included in the received extension rule, necessary for adding a data item. The data set 76 sends the data item addition detailed information and a data item adding request to the DBMS 74.

When the ScanToE-mail plug-in 111 is added, the data item addition detailed information to be added is “e-mail address” with the data item type “character string”. The data set 76 checks and determines, for example, not to add the data item “user name” because the “user name” is already registered as a data item of the original user information.

When the DBMS 74 receives the data item adding request, the DBMS 74 adds the requested data item according to the data item adding request to the user information of the DB managed by the DBMS 74. As described above, the multifunctional product can add the ScanToE-mail information item necessary to realize the ScanToE-mail function when the ScanToE-mail plug-in 111 is installed.

It should be noted that when one plug-in component is installed, a data item with respect to plural data set 76 can be extended. For example, when the FAX plug-in 72 is installed, in an actual multifunction product, it may be necessary to extend not only the DB user information data set but also the CVS apparatus information data set (addition of FAX unit information item) that is not shown in drawings including the sequence diagram of FIG. 7 for simplification purposes.

### (Addition of Document Box Function)

In a multifunctional product according to an embodiment of the present invention, a document box function will be able to be used by installing a document box plug-in component (hereinafter simplified as “document box plug-in”) as one of the additional components 31. In this case, a table of the archive information necessary for realizing the document box function is added as a table handled by the data management component 73.

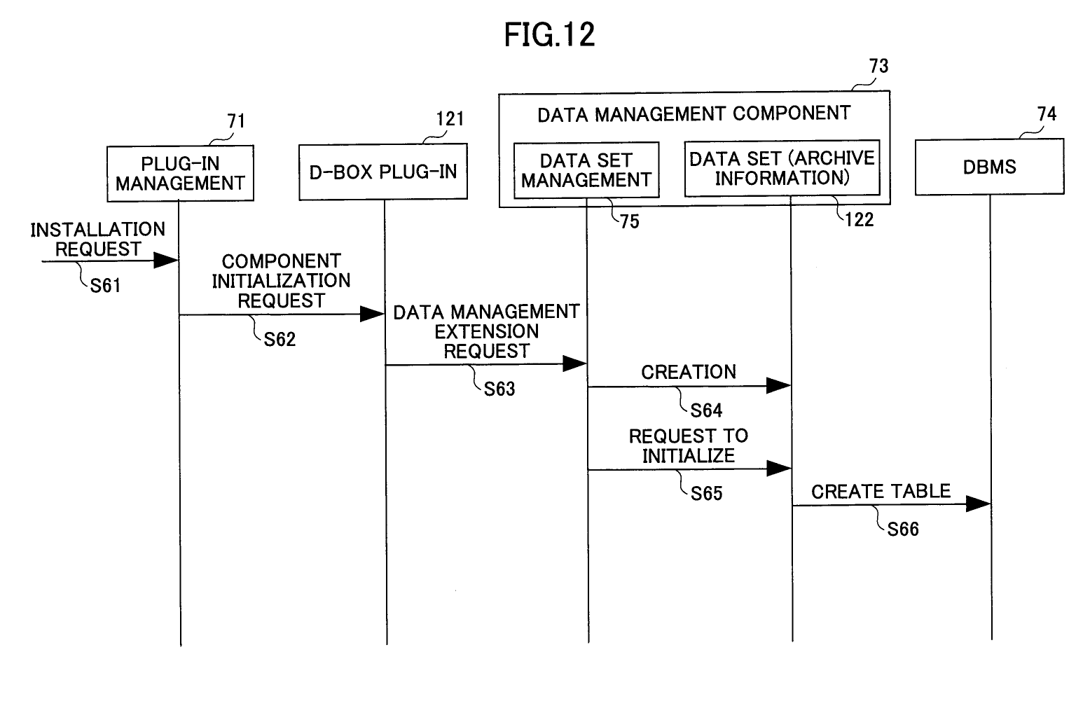

FIG. 12 is a sequence diagram showing a process of the multifunctional product when the document box function is added. The document box (D-BOX) plug-in 121 shown in FIG. 12 is included in the application logic 13 shown in FIG. 2.

In step S61, when the plug-in management 71 receives the installation request of the document box plug-in, the plug-in management 71 searches for the document box plug-in 121 as the target component. In step S62, the plug-in management 71 sends a component initialization request to the target component.

When the document box plug-in 121 receives the component initialization request, the document box plug-in 121 configures the environment required to initiate the target component. The document box plug-in 121 transmits the usage data item and a data management extension request to the data management component 73 as one of the operations of configuring the environment. When the document box plug-in 121 is added, the usage data items to be added are “document name” and “created user name” as usage data item names of “archive information” as a usage data set.

When the data set management 75 in the data management component 73 receives the data management extension request, the data set management 75 searches for the data set 76 managing the target table. For example, in the sequence diagram of FIG. 12, the target table cannot be searched out. Therefore, the data set management 75 creates a new data set 122 for the archive information (that is, an instance, known as an object-oriented term, is created) in step S64. In this case, the data set management 75 specifies the DBMS 74 as the storage destination of the table of the archive information. In step S65, the data set management 75 sends an initialization request to the data set 122.

In step S66, when the data set 122 in the data management component 73 receives the initialization request, the data set 122 sends the data item detailed information of the table managed by the data set 122 and a table creating request to the DBMS 74.

For example, when the document box plug-in 121 is added, the detailed information data items to be added are “document name”, “created user name”, and “creation date”. When the DBMS 74 receives the table creating request, the DBMS 74 creates a table of the archive document information in the DB managed by the DBMS 74. It should be noted that the initialization process in step S65 may be realized by the method using a so-called “constructor” known as an object-oriented term.

In a multifunctional product according to the embodiment of the present invention, when the document box plug-in 121 is installed in the multifunctional product, a table of archive information required to realize the document box function can be added as a table handled in the data management component 73.

### (Reason of Existence of Data Management Component 73)

It is conceived that the data management component 73 may be unified with the DBMS 74. But in such a case, for example, when the data management component 73 is unified with the DBMS 74 and a plug-in component is directly connected to the DBMS 74, the following problem arises.

When the accessing method to the DBMS 74 is changed by, for example, replacing the parts of the data base, it is necessary to modify the accessing part in the plug-in component to the DBMS 74. Furthermore when a new plug-in component is created and the new plug-in component requires the extension of the data base, the creator of the plug-in component needs to know how to access the DBMS 74 and how to implement the part to access the DBMS 74 in the plug-in component.

Further, when the data are stored not only in the DBMS 74 but also in, for example, a remote data server and a file separated from the multifunctional product, the creator needs to implement a function to access the remote server and the file in all the plug-in components.

To solve the problems, according to the embodiment of the present invention, it is possible to hide the above-mentioned data access procedure by the existence of the data management component 73.

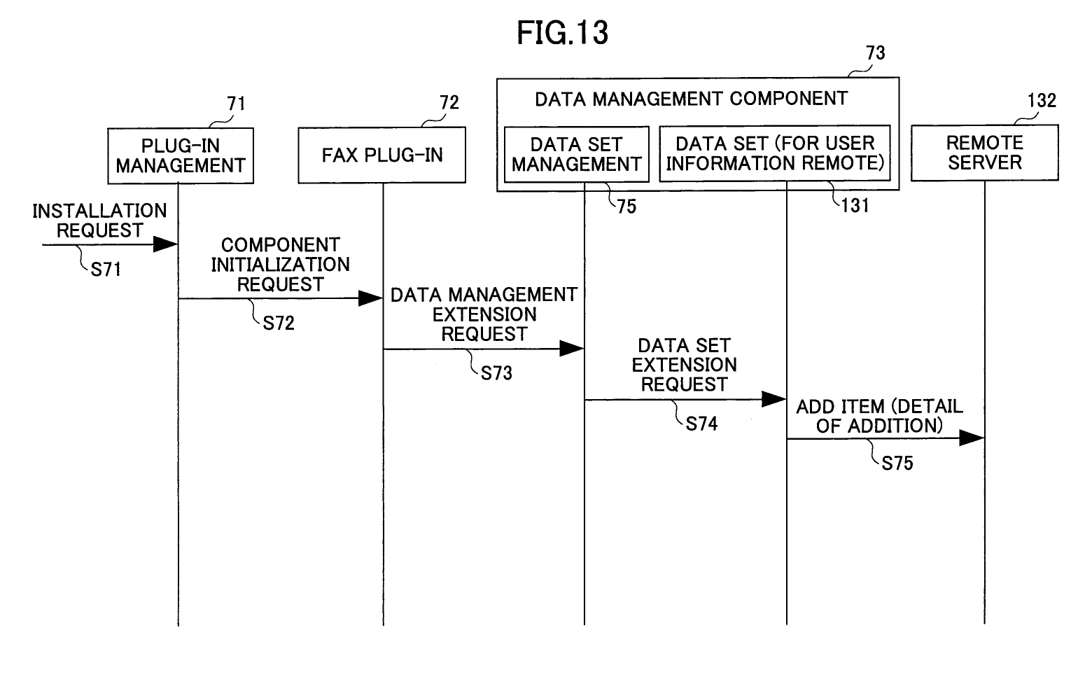

FIG. 13 is a sequence diagram showing a process in the multifunctional product when the FAX function is added and a table of a remote data server is extended. In step S71, when the plug-in management 71 receives the installation request of the FAX plug-in, the plug-in management 71 searches out the FAX plug-in 72 as a target component. In step S72, the plug-in management 71 sends a component initializing request to the searched out target component.

When the FAX plug-in 72 receives the component initializing request, the FAX plug-in 72 configures the environment required to initiate the target component. The FAX plug-in creates an extension rule of the data management as one of the operations of configuring the environment.

In step 73, the FAX plug-in 72 sends the usage data item and a data management extension request to the data management component 73. When the data set management 75 in the data management component 73 receives the data management extension request, the data set 131 of remote user information managing the target table is searched out. When the data set 131 is searched out, the data set management 75 sends the additional candidate data item and a data set extension request to the data set 131 in the step S74.

In step S75, when the data set 131 in the data management component 73 receives the data set extension request, the data set 131 refers to the information, included in the received extension rule, necessary for adding a data item and sends data item addition detailed information and a data item adding request to a remote data server 132. When the remote data server 132 receives the data item adding request, the remote data server 132 adds the data item according to the request in the data item adding request to the user information of the DB managed by the remote data server 132.

The process of steps S71 through S73 shown in the sequence diagram of FIG. 13 is substantially the same as the process of steps S11 through S13 until the data set management 75 receives the data management extension request shown in the sequence diagram of FIG. 7.

Therefore, even when the storage place of data is changed from the DBMS 74 to the remote data server 132, the data set 131 handles the difference and accordingly the FAX plug-in 72, requesting the data extension, does not have to know the difference in the data access process and the extension can be performed easily. This is also applicable to the sequence diagrams of FIGS. 11 and 12.

According to the embodiment of the present invention, a plug-in component with an adding function implemented in the plug-in component has the knowledge so as to extend the information (permanent information) required to perform the adding function. Also, the data management component 73, managing the storage place of the permanent information (for example, a DB and a file), receives an extension request of the permanent information from the plug-in component and implements a function to perform the extension of the permanent information based on the extension request.

The data management component 73 includes a data set 33 managing the physical storage place of data (for example, a DB table, an XML file, and a CVS file), and a data set management 32 managing one or more data sets 33.

According to the feature of the present invention, when a plug-in having an adding function is installed, the information required to perform the adding function can easily be extended.

### (A Detail of the Embodiment of the Present Invention)

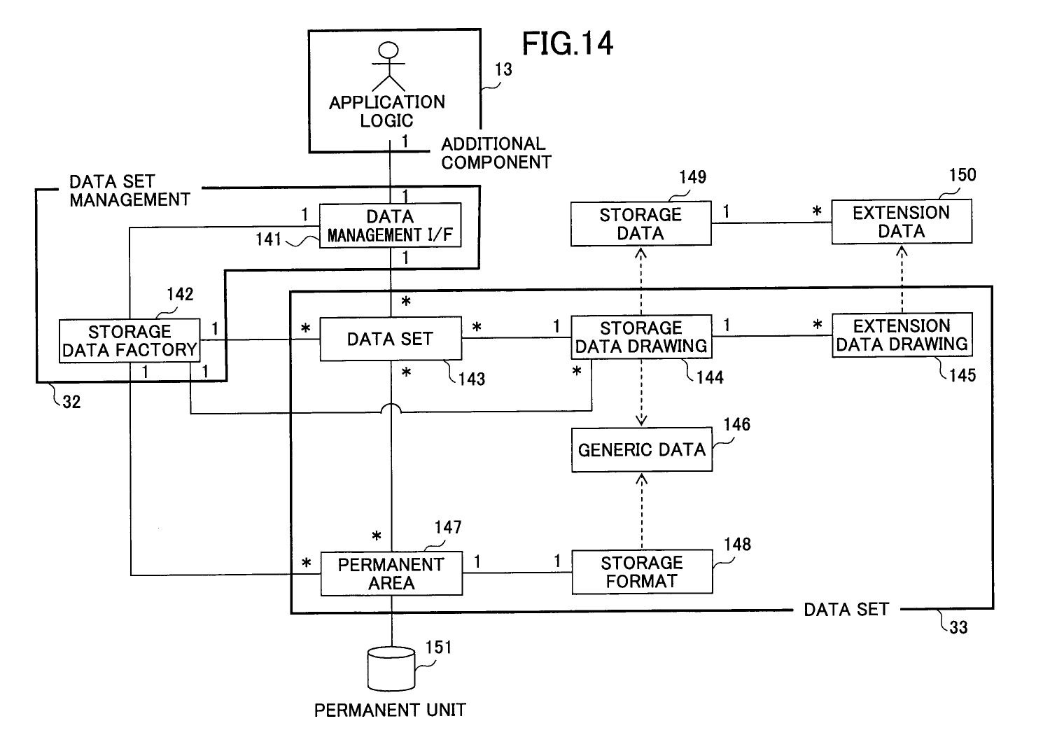

FIG. 14 is a class diagram showing a detail of an embodiment of the present invention. The parts shown in the drawing of FIG. 14 include the application logic 13, a data management I/F class 141, a storage data factory class 142, a data set class 143, a storage data drawing class 144, an extension data drawing class 145, a generic data class 146, a permanent area class 147, a storage format class 148, a storage data class 149, an extension data class 150, and a permanent unit 151.

The application logic 13 constitutes the above-mentioned additional component 31. The data management I/F class (hereinafter simplified as “data management I/F”) 141 and the storage data factory class (hereinafter simplified as “storage data factory”) 142 constitute the above-mentioned data set management 32.

Further, the data set class (hereinafter simplified as “data set”) 143, the storage data drawing class (hereinafter “storage data drawing”) 144, the extension data drawing class (hereinafter “extension data drawing”) 145, the generic data class (hereinafter “generic data”) 146, the permanent area class (hereinafter “permanent area”) 147, and the storage format class (hereinafter “storage format”) 148 constitute the above-mentioned data set 33. Still further, the storage data drawing 144 and the extension data drawing 145 constitute the above-mentioned extension rule of data management.

Regarding the parts shown in the class diagram of FIG. 14, the sequences and the processes of the data registration, data search, data update, data deletion, extension data drawing addition, extension data drawing deletion, storage data drawing addition, storage data drawing deletion, data set creation, data set deletion, and data conversion are described below with reference to the accompanying corresponding sequence diagrams and the flowcharts.

### (Data Registration)

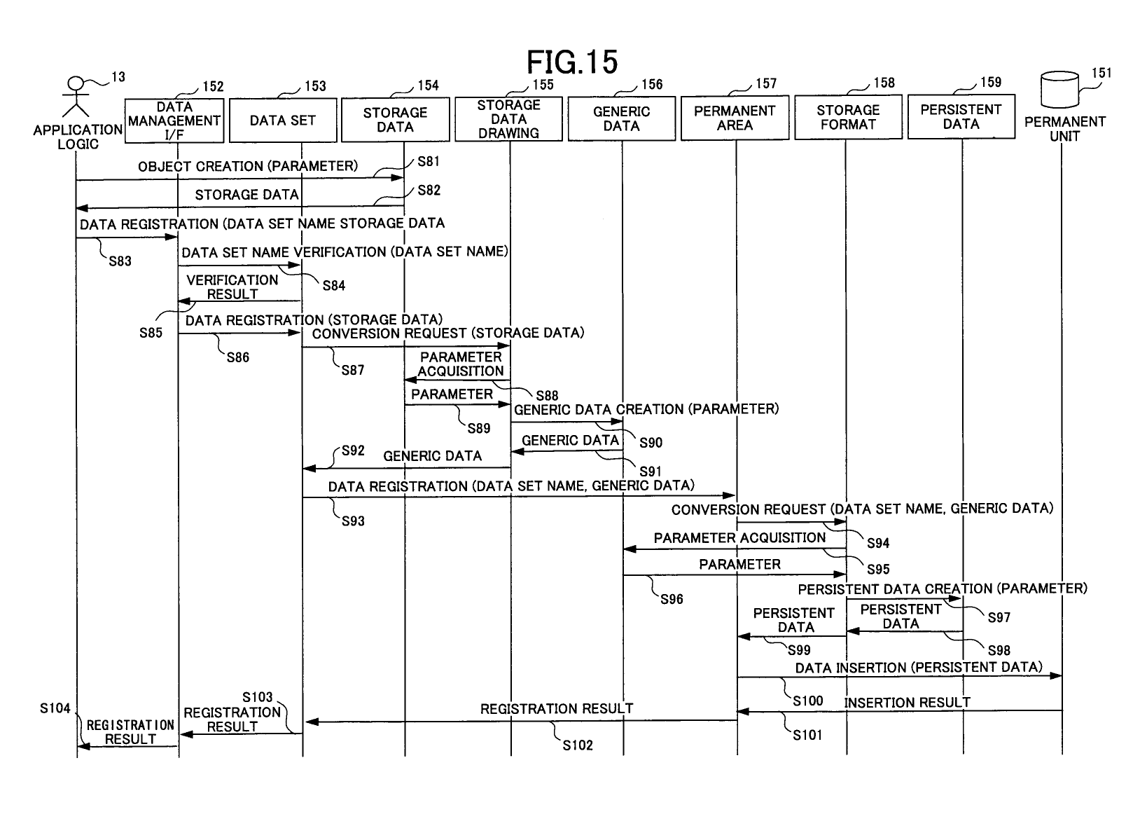

FIG. 15 is a sequence diagram showing an example of a process of data registration. In step S81, the application logic 13 performs an object creation request by specifying a parameter to create storage data 154. In step S82, the application logic 13 obtains the storage data 154. Here, the storage data 154 refer to the data usable by the application logic 13.

In step S83, the application logic 13 sends a data registration request to a data management IF 152 by specifying the data set name and the protection data 154. In step S84, the management IF 152 sends a data set name verification request to a data set 153 by specifying the data set name. In step S85, the data set 153 returns the verification result of the data set name verification request to the data management IF 152. Here, the data set 153 refers to the component storing a permanent area 157 corresponding to the data and expressing a unit of data that the application logic is aware of.

When the data name of the data set 153 is the same data set name specified in the data registration request, the process goes to step S86 and the data management IF 152 sends the data registration request to the data set 153 by specifying the storage data 154 specified in the data registration request.

In step S87, the data set 153 sends a conversion request to a storage data drawing 155 by specifying the storage data 154 specified in the data registration request. Here, the storage data drawing refers to the component performing a mutual conversion between storage data 154 and generic data 156. In step S88, the storage data drawing 155 sends a parameter acquisition request to the storage data 154. In step S89, the storage data drawing 155 obtains the parameter of the storage data 154.

In step 90, the storage data drawing 155 performs a generic data creation request by specifying a parameter to create generic data 156. In step S91, the storage data drawing 155 obtains the generic data 156. Here, the generic data 156 refer to the collective data set of the data item name and the data item value.

In step S92, the data set 153 obtains the generic data 156. In step S93, the data set 153 sends a data registration request to permanent area 157 by specifying the data set name and the generic data 157. Here, the permanent area refers to the component hiding the accessing method (a procedure of data access) to the permanent unit 151.

In step S94, the permanent area 157 sends a conversion request to a storage format 158 by specifying the data set name and the generic data 156 specified in the data registration request.

Here, the storage format 158 refers to the component performing a mutual conversion between the generic data 156 and persistent data 159.

In step S95, the storage format 158 performs a parameter acquisition request of the generic data 156. In step S96, the storage format 158 obtains the parameter of the generic data 156.

In step S97, the storage format 158 performs a persistent data generation request by specifying a parameter to create the persistent data 159. In step S98, the storage format 158 obtains the persistent data 159. Here, the persistent data 159 refer to the data expressed in the data format stored in the permanent unit 151.

In step S99, the permanent area 157 obtains the persistent data 159. In step S100, the permanent area 157 sends a data insertion request to the permanent unit 151 by specifying the persistent data 159. In step S101, the permanent area 157 receives the insertion result from the permanent unit 151. Though the permanent area 157 sends a data insertion request to the permanent unit 151 in FIG. 15, the storage format 158 may alternatively send the data insertion request to the permanent unit 151.

In step S102, the data set 153 receives the registration result from the permanent area 157. In step S103, the data management IF 152 receives the registration result from the data set 153. In step S104, the application logic 13 receives the registration result.

As described above, in a multifunctional product according to the embodiment of the present invention, the application logic 13 can send a request to register the storage data 154 in the permanent unit 151 so that the application logic 13 can realize the function.

### (Data Search)

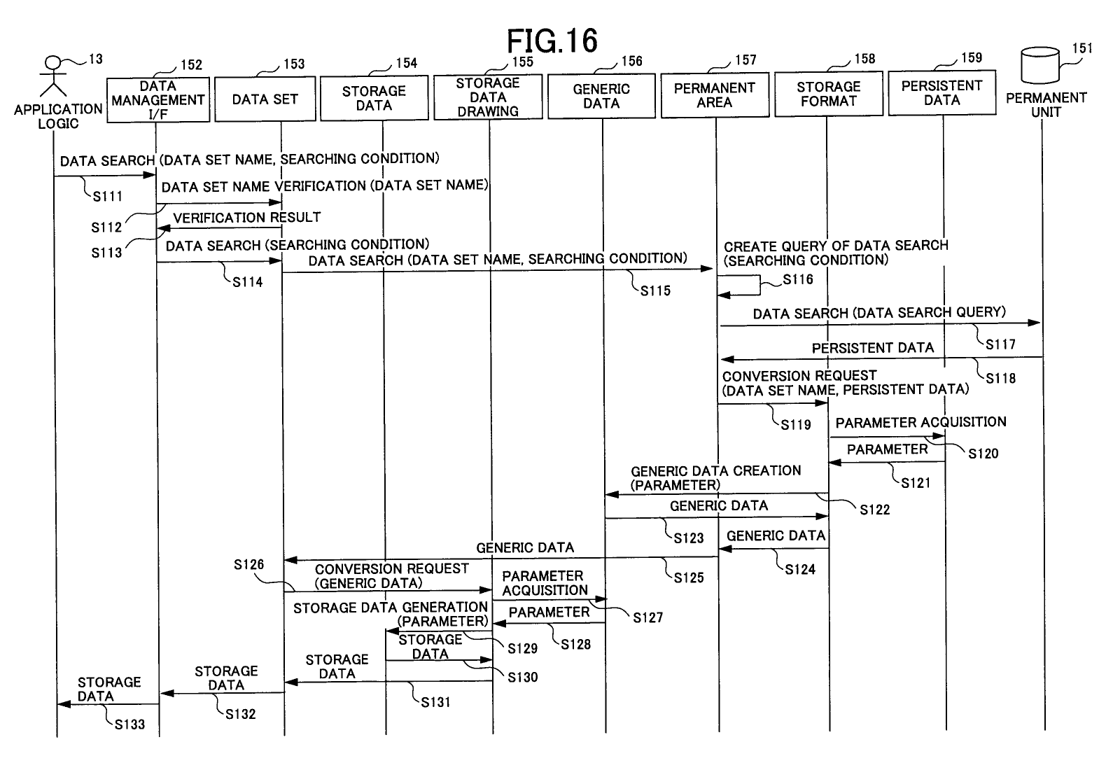

FIG. 16 is a sequence diagram showing an exemplary process data search. In step S111, the application logic 13 sends a data search request to the data management IF 152 by specifying the data set name and the searching condition.

In step S112, the data management IF 152 sends a data set name verification request to the data set 153 by specifying the data set name. In step 113, the data set 153 sends the verification result to the data management IF 152.

When the data set name of the data set 153 is the same data set name specified by the data search request, the process goes to step S114 and the data management IF 152 sends a data search request to the data set 153 by specifying the searching condition specified by the data search request. In step S115, the data set 153 sends a data search request to the permanent area 157 by specifying the data set name and the searching condition.

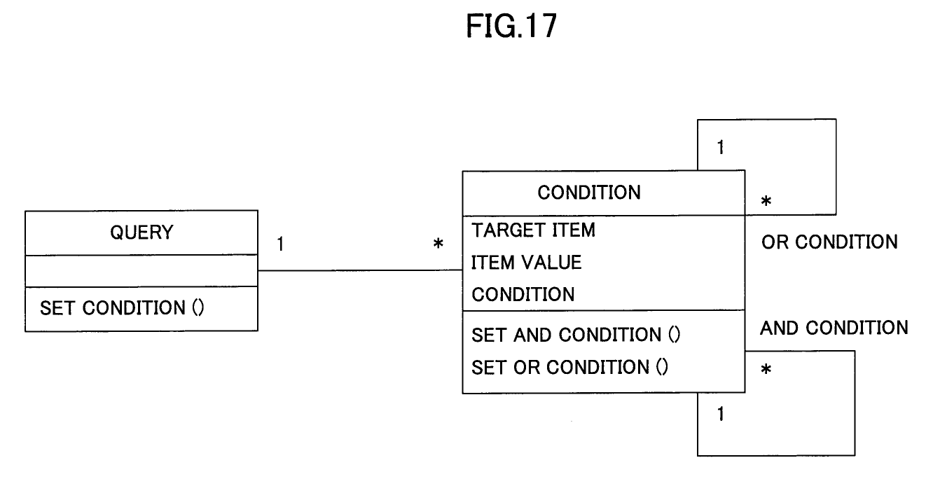

In step 116, the permanent area 157 performs to create a data search query by specifying a searching condition. An exemplary relationship between the searching condition and the data search query is shown in FIG. 17. FIG. 17 is a class diagram showing the relationship between the searching condition and the data search query.

In step S117, the permanent area 157 sends a data search request to the permanent unit 151 by specifying the data search query. In step S118, the permanent area 157 receives persistent data of the search result from the permanent unit 151.

In step 119, the permanent area 157 sends a conversion request to the storage format 158 by specifying the data set name and the persistent data. In step 120, the storage format 158 sends a parameter acquisition request of the persistent data 159. In step S121, the storage format 158 obtains the parameter of the persistent data 159.

In step S122, the storage format 158 performs a generic data creation request by specifying a parameter to create generic data 156. In step S123, the storage format 158 obtains the generic data 156.

In step S124, the permanent area 157 obtains the generic data 156. In step S125, the data set 153 obtains the generic data. In step S126, the data set 153 sends a conversion request to the storage data drawing 155 by specifying the generic data 156.

In step S127, the storage data drawing 155 performs a parameter acquisition request of the generic data 156. In step S128, the storage data drawing 155 obtains the parameter of generic data 156.

In step S129, the storage data drawing 155 performs a storage data creation request by specifying a parameter to create the storage data 154. In step S130, the storage data drawing 155 obtains the storage data 154.

In step S131, the data set 153 obtains the storage data 154. In step S132, the data management IF 152 receives the storage data 154 from the data set 153. In step S133, the application logic 13 receives the storage data 154.

As described above, in a multifunctional product according to the embodiment of the present invention, the application logic 13 can send a request to search for the persistent data 159 corresponding to the searching condition from among the persistent data 159 registered in the permanent unit 151.

### (Data Update)

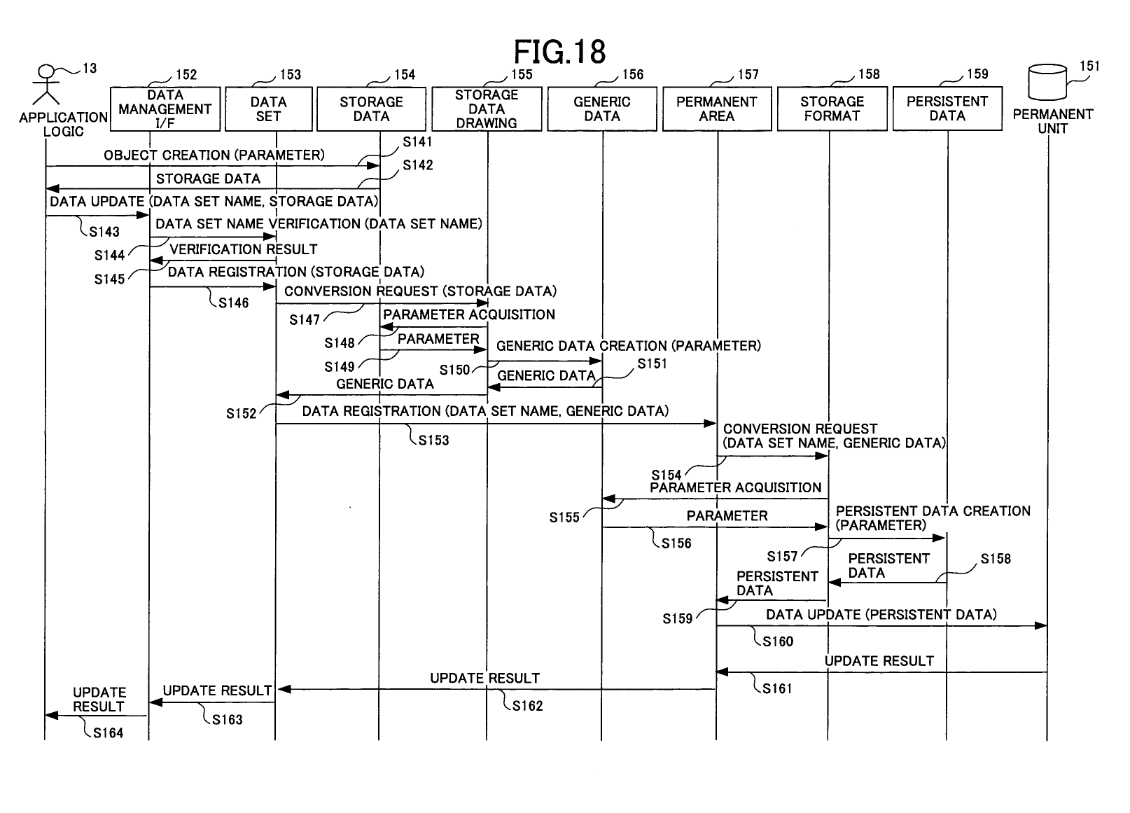

FIG. 18 is a sequence diagram showing an exemplary process of the data update. First, in step S141, the application logic 13 performs an object creation request by specifying a parameter to create the storage data 154. In step S142, the application logic 13 obtains the storage data 154. In step S143, the application logic 13 sends a data update request to the data management IF 152 by specifying the storage data 154.

In step S114, the data management IF 152 sends a data set name verification request to the data set 153 by specifying the data set name. In step S145, the data set 153 returns the verification result of the data set name verification request to the data management IF 152.

When the data set name of the data set 153 is the same as the data set name specified by the data update request, the process goes to step S146 and the data management IF 152 sends a data registration request to the data set 153 by specifying the storage data 154 specified in the data update request. In step S147, the data set 153 sends a conversion request to the storage data drawing 155 by specifying the storage data 154 specified in the data update request.

In step S148, the storage data drawing 155 performs a parameter acquisition request of the storage data 154. In step S149, the storage data drawing 155 obtains the parameter of the storage data 154.

In step 150, the storage data drawing 155 performs a generic data creation request by specifying a parameter to create the generic data 156. In step 151, the storage data drawing 155 obtains the generic data 156. In step 152, the data set 153 obtains the generic data 156. In step S153, the data set 153 sends a data update request to the permanent area 157 by specifying the data set name and the generic data 156.

In step S154, the permanent area 157 sends a conversion request to the storage format 158 by specifying the data set name and the generic data 156 specified in the data update request. In step S155, the storage format 158 performs a parameter acquisition request of the generic data 156. In step S156, the storage format 158 obtains the parameter of the generic data 156.

In step S157, the storage format 158 performs a persistent data creation request by specifying a parameter to create the persistent data 159. In step S158, the storage format 158 obtains the persistent data 159.

In step S159, the storage format 158 obtains the persistent data 159. In step S160, the permanent area 157 sends a data update request to the permanent unit 151 by specifying the persistent data 159. In step S161, the permanent area 157 receives the update result of the data update request from the permanent unit 151. Though the permanent area 157 sends a data update request to the permanent unit 151 in the sequence drawing of FIG. 18, the storage format 158 may alternatively send the data update request.

In step S162, the data set 153 receives the update result from the permanent area 157. In step S163, the data management IF 152 receives the update result from the data set 153. Then, in step S164, the application logic 13 receives the update result.

As described above, in a multifunctional product according to the embodiment of the present invention, the application logic 13 can send a request to update the persistent data 159 registered in the permanent unit 151. Further, in the update process, the data can be updated effectively since only a data item to be updated is being updated.

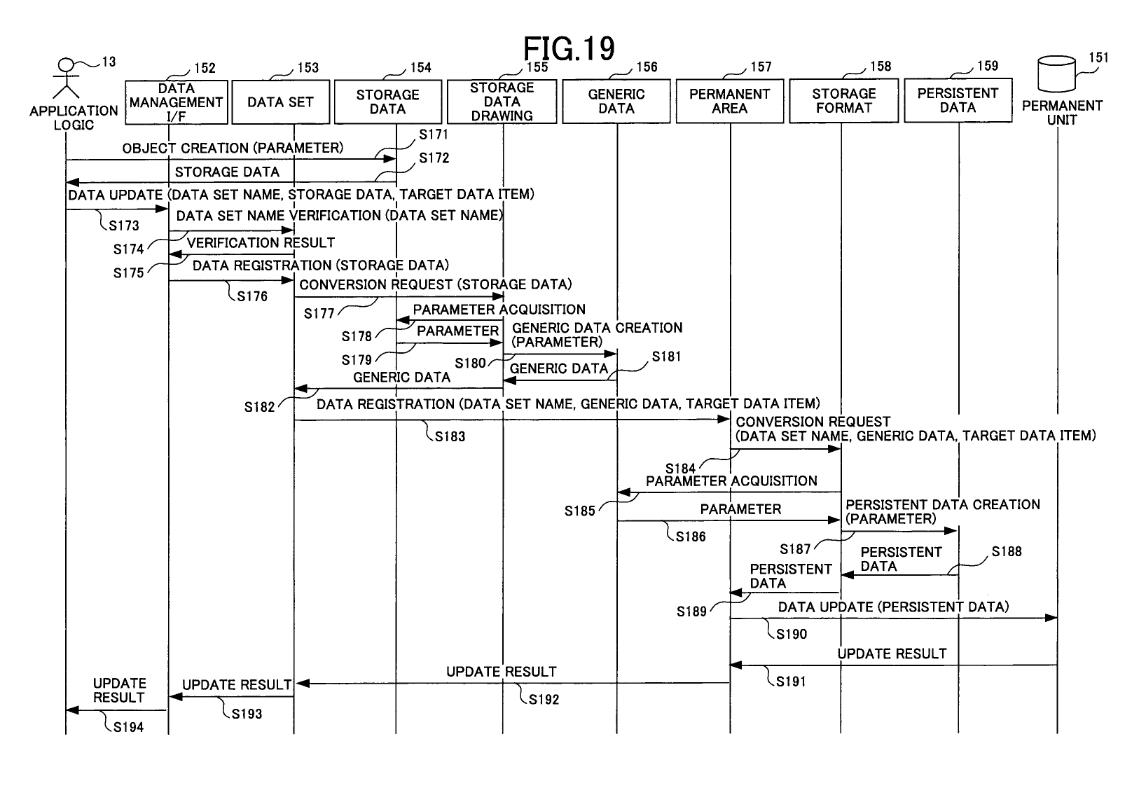

FIG. 19 is a sequence diagram showing another exemplary process of the data update. The sequence steps of FIG. 19 are the same as those of FIG. 18 except steps S173, S183 and S184 as described below.

In step S173, the application logic 13 sends the data update request to the data management IF 152 by specifying a target data item in addition to the data set name and storage data 154 specified in step S143 in FIG. 18.

In step S183, the data set 153 sends the data update request to the permanent area 157 by specifying the target data item in addition to the data set name and the generic data 156 specified in step S153 in FIG. 18.

In step S184, the permanent area 157 sends the conversion request to the storage format 158 by specifying the target data item in addition to the data set name and the generic data 156 specified in step S153 in FIG. 18. It should be noted that the conversion request from the generic data 156 to the persistent data 159 when persistent data are created use the same IF as in step S184. In this case, select “all” for the target data item.

As described above, in a multifunctional product according to the embodiment of the present invention, the application logic 13 can send a request to update only the data item to be updated among the persistent data 159 registered in the permanent unit 151.

### (Data Deletion)

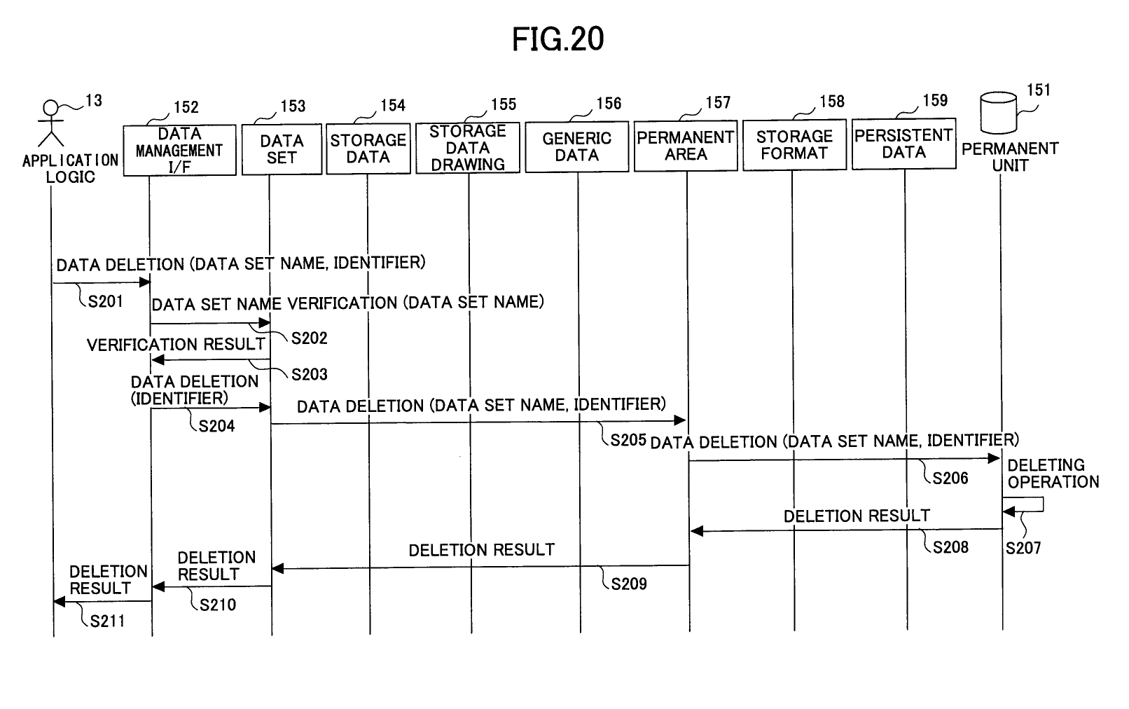

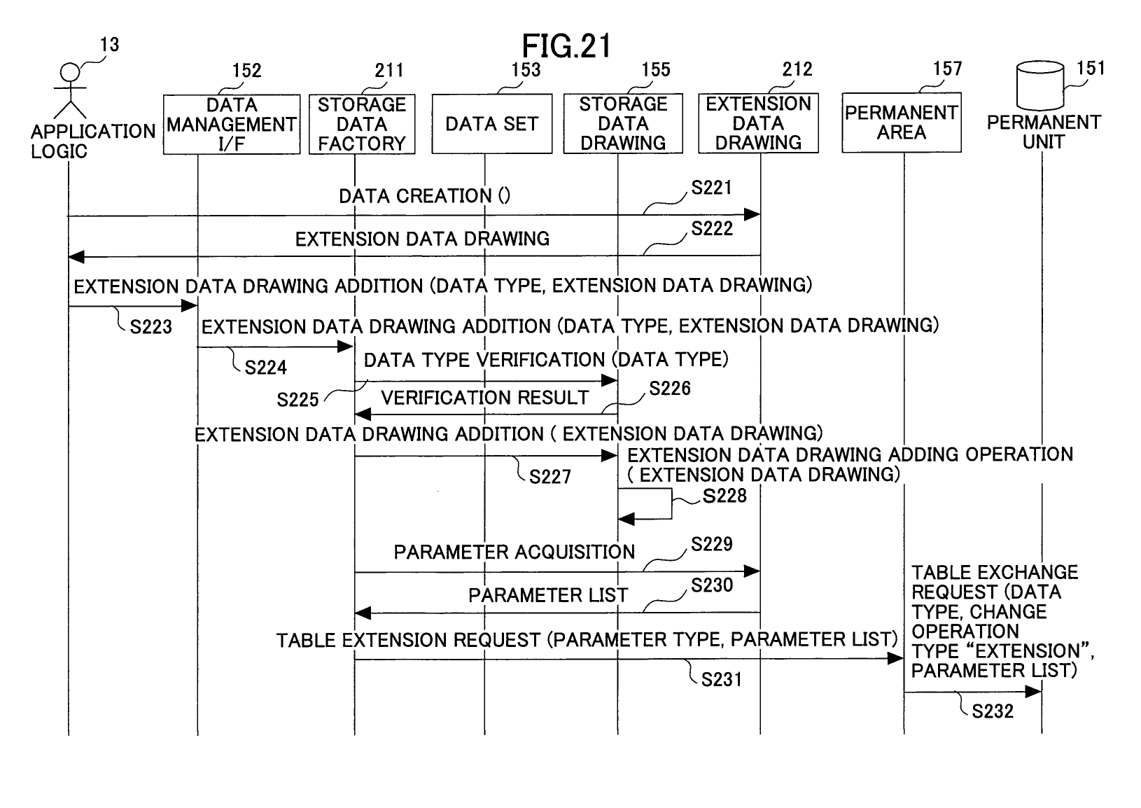

FIG. 20 is a sequence diagram showing an exemplary process of data deletion. In step S201, the application logic 13 sends a data deletion request to the data management IF 152 by specifying the data set name and an identifier. Here, the identifier refers to an ID number included in the storage data 154 obtained through the data search.

In step S202, the data management IF 152 sends a data set name verification request to the data set 153 by specifying the data set name. In step S203, the data set 153 sends the verification result to the data management IF 152.

When the data set name of the data set 153 is the same data set name as that specified in the data deletion request, the process goes to step 204 and the data management IF 152 sends the data deletion request to the data set 153 by specifying the identifier specified in the data deletion request. In step S205, the data set 153 sends the data deletion request to the permanent area 157 by specifying the data set name and the identifier.

In step S206, the permanent area 157 sends the data deletion request to the permanent unit 151 by specifying the data set name and the identifier. In step S207, the permanent unit 151 deletes the persistent data 159 corresponding to the identifier. In step S208, the permanent area 157 receives the deletion result from the permanent unit 151. In step S209, the data set 153 receives the deletion result from the permanent area 157. In step S210, the data management IF receives the deletion result from the data set 153. Then, in step S211, the application logic 13 receives the deletion result.

As described above, in a multifunctional product according to the embodiment of the present application, the application logic 13 can send a request to delete persistent data 159 registered in the permanent unit 151.

### (Extension Data Drawing Addition)

FIG. 21 is a sequence diagram showing an exemplary process of extension data drawing addition. In step S221, the application logic 13 performs a data creation request to create an extension data drawing 212. In step S222, the application logic 13 obtains the extension data drawing 212. Here, the extension data drawing 212 refers to the component performing a mutual conversion between extension data and generic data. The extension data refers the data capable of being used by the application logic 13 but excluding the storage data 154.

In step S223, the application logic 13 sends an extension data drawing addition request to the data management IF 152 by specifying a data type and the extension data drawing 212. In step S224, the data management IF 152 sends the extension data drawing addition request to a storage data factory 211 by specifying the data type and the extension data drawing 212.

In step S225, the storage data factory 211 sends a data type verification request to the storage data drawing 155 by specifying the data type. In step S226, the storage data drawing 155 returns the verification result of the data type verification request to the storage data factory 211.

In step S227, the storage data factory 211 sends the extension data drawing addition request to the storage data drawing 155 by specifying the extension data drawing 212. In step S228, the storage data drawing 155 performs an extension data drawing adding operation by specifying the extension data drawing 212.

When the extension data drawing adding operation in step S228 is finished, the process goes to step S229 and the storage data factory 211 sends a parameter acquisition request to the extension data drawing 212. In step S230, the storage data factory 211 receives the parameter list from the extension data drawing 212.

In step S231, the storage data factory 211 sends a table extension request to the permanent area 157 by specifying the data type and the parameter list. In step S232, the permanent area 157 sends a table exchange request to the permanent unit 151 by specifying the data type, a change operation type “Extension”, and the parameter list.

As described above, in a multifunctional product according to the embodiment of the present invention, the application logic 13 can send a request to add the extension data drawing 212.

### (Extension Data Drawing Deletion)

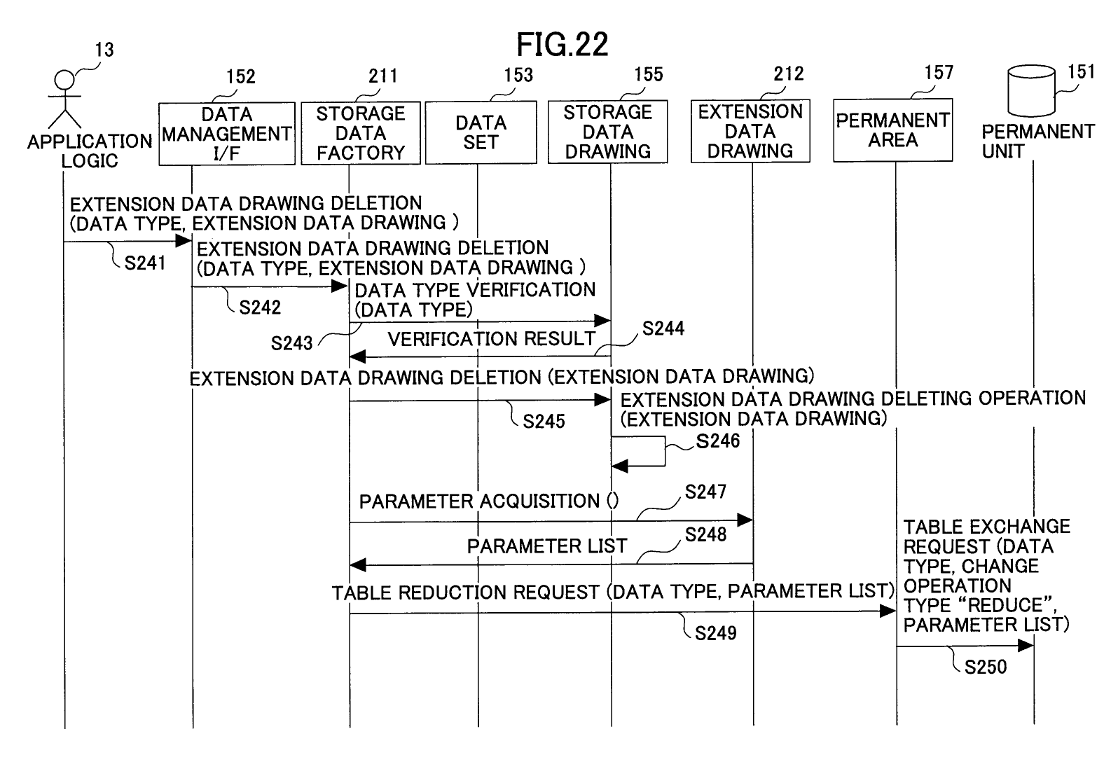

FIG. 22 is a sequence diagram showing an exemplary process of extension data drawing deletion. In step S241, the application logic 13 sends an extension data drawing deletion request to the data management IF 152 by specifying the data type and the extension data drawing 212. In step S242, the data management IF 152 sends the extension data drawing deletion request to the extension data drawing 212 by specifying the data type and the extension data drawing 212.

In step S243, the storage data factory 211 sends a data type verification request to the storage data drawing 155 by specifying the data type. In step S244, the storage data drawing 155 sends the verification result of the data type verification request to the storage data factory 211.

In step S245, the storage data factory 211 sends the extension data drawing deletion request to the storage data drawing 155 by specifying the extension data drawing 212. In step S246, the storage data drawing 155 performs an extension data drawing deleting operation by specifying the extension data drawing 212.

When the extension data drawing deleting operation in step S246 is finished, the process goes to step S247 and the storage data factory 211 sends a parameter acquisition request to the extension data drawing 212. In step S248, the storage data factory 211 receives a parameter list from the extension data drawing 212.

In step S249, the storage data factory 211 sends a table reduction request to the permanent area 157 by specifying the data type and the parameter list. In step S250, the permanent area 157 sends a table exchange request to the permanent unit 151 by specifying the data type, the change operation type “reduce”, and the parameter list.

As described above, in a multifunctional product according to the embodiment of the present invention, the application logic 13 can send a request to delete the extension data drawing 212.

### (Storage Data Drawing Addition)

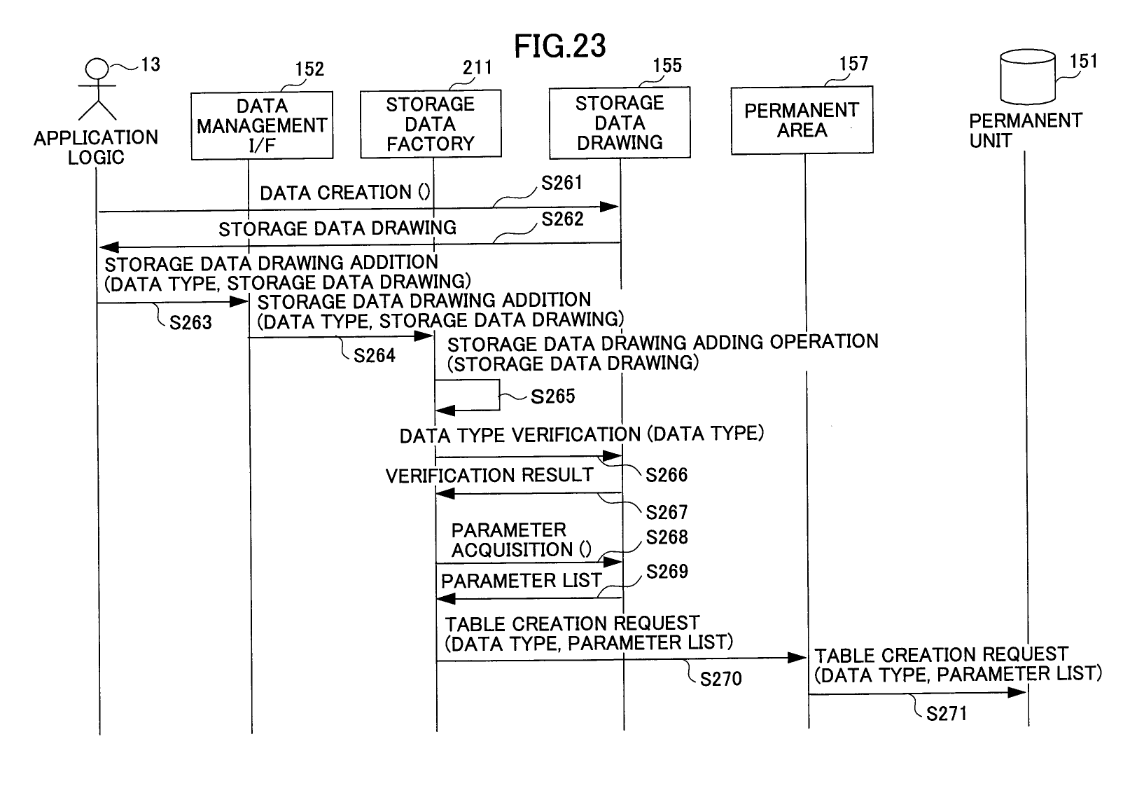

FIG. 23 is a sequence drawing showing an exemplary process of storage data drawing addition.

In step S261, the application logic 13 performs a data creation request to create a storage data drawing 155. In step S262, the application logic 13 receives the storage data drawing 155.

In step S263, the application logic 13 sends a storage data drawing addition request to the data management IF 152 by specifying the data type and the storage data drawing 155. In step S264, the data management IF 152 sends the storage data drawing addition request to the storage data factory 211 by specifying the data type and the storage data drawing 155.

In step S265, the storage data factory 211 performs a storage data drawing adding operation by specifying the storage data drawing 155. In step S266, the storage data factory 211 sends a data type verification request to the storage data drawing 155 by specifying the data type. In step S267, the storage data drawing 155 sends the verification result to the storage data factory 211.

In step S268, the storage data factory 211 sends a parameter acquisition request to the storage data drawing 155. In step S269, the storage data factory 211 receives a parameter list from the storage data drawing 155.

In step S270, the storage data factory 211 sends a table creation request to the permanent area 157 by specifying the data type and the parameter list. In step S271, the permanent area 157 sends the table creation request to the permanent unit 151 by specifying the data type and the parameter list.

As described above, in a multifunctional product according to the embodiment of the present invention, the application logic 13 can send a request to add the storage data drawing 155.

### (Storage Data Drawing Deletion)

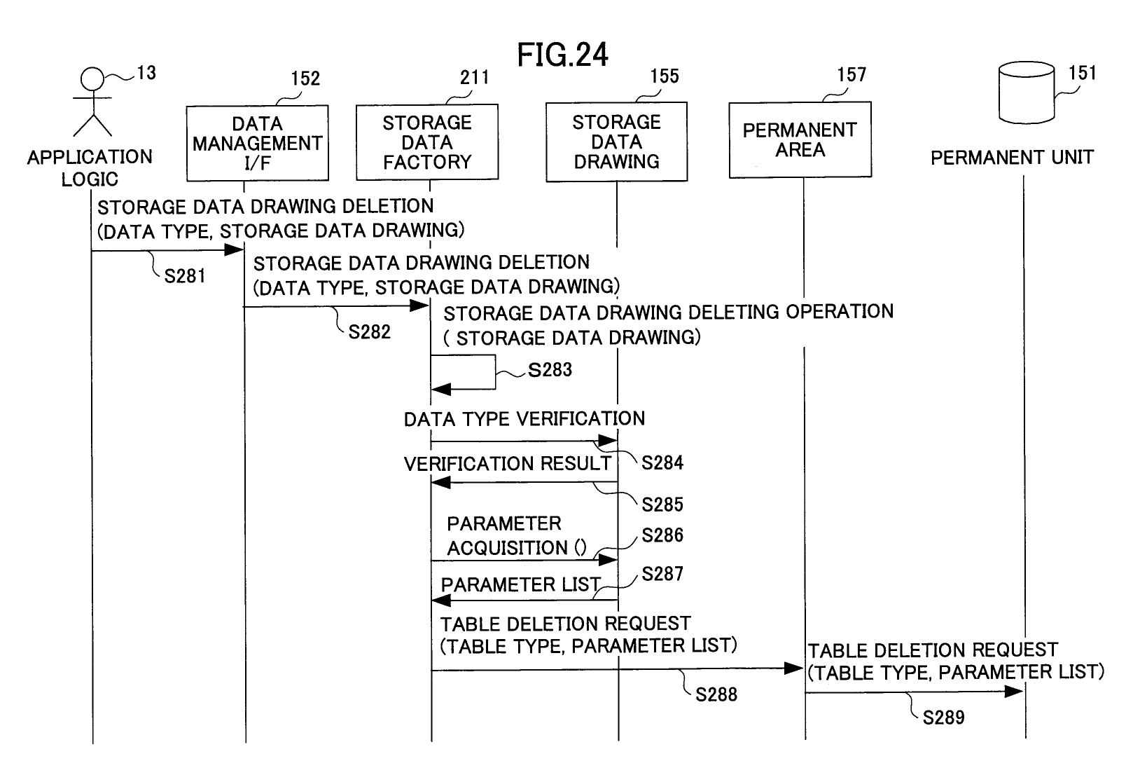

FIG. 24 is a sequence diagram showing an exemplary process of storage data drawing deletion.

In step S281, the application logic 13 sends a storage data drawing deletion request to the data management IF 152 by specifying the data type and the storage data drawing 155. In step S282, the data management IF 152 sends the storage data drawing deletion request to the storage data factory 211 by specifying the data type and the storage data drawing 155.

In step S283, the storage data factory 211 performs a storage data drawing deleting operation by specifying the storage data drawing 155. In step S284, the storage data factory 211 sends a data type verification request to the storage data drawing 155. In step S285, the storage data drawing 155 sends the verification result of the data type verification request to the storage data factory 211.

In step S286, the storage data factory 211 sends a parameter acquisition request to the storage data drawing 155. In step S287, the storage data factory 211 receives a parameter list from the storage data drawing 155.

In step S288, the storage data factory 211 sends a table deletion request to the permanent area 157 by specifying the data type and the parameter list. In step S289, the permanent area 157 sends the table deletion request to the permanent unit 151 by specifying the data type and the parameter list.

As described above, in a multifunctional production according to the embodiment of the present invention, the application logic 13 can send a request to delete the storage data drawing 155.

### (Data Set Creation)

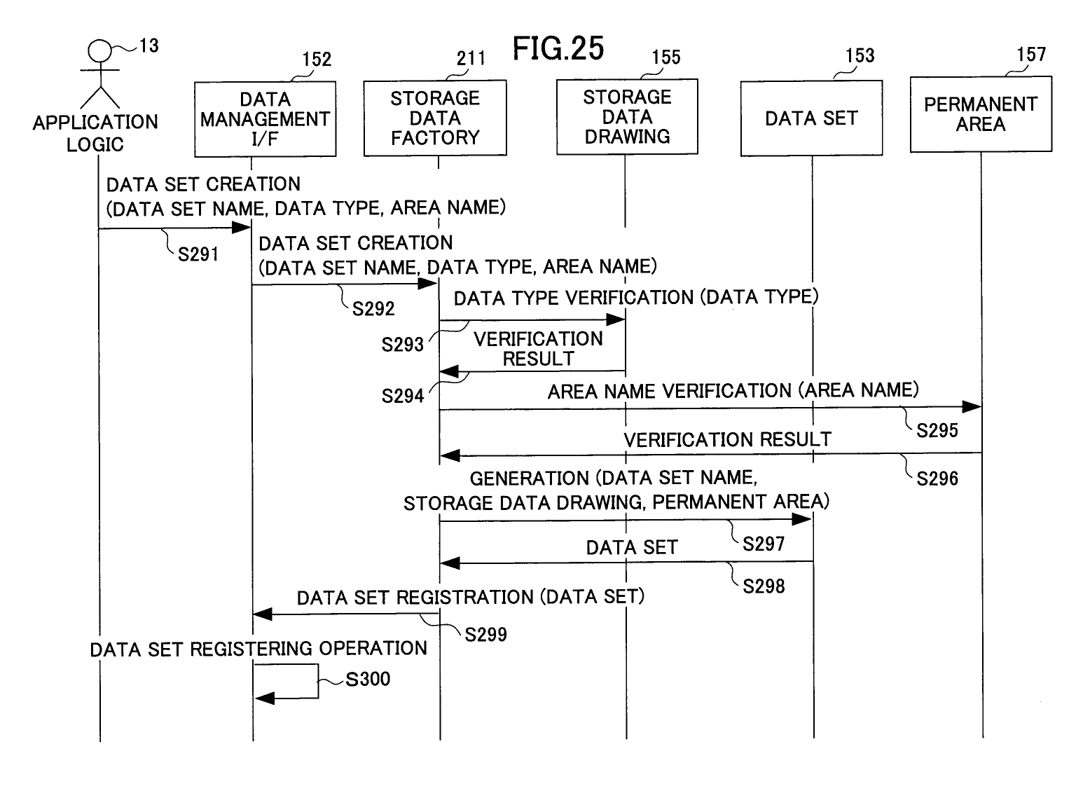

FIG. 25 is a sequence diagram showing an exemplary process of data set creation. In step S291, the application logic 13 sends a data set creation request to the data management IF 152 by specifying the data set name, the data type and an area name.

In step S292, the data management IF 152 sends a data set addition request to the storage data factory 211 by specifying the data set name, the data type, and the area name. In step S293, the storage data factory 211 sends a data type verification request to the storage data drawing 155. In step S294, the storage data factory receives the verification result of the data type from the storage data drawing 155.

In step S295, the storage data factory 211 sends an area name verification request to the permanent area 157 by specifying the area name. In step S296, the storage data factory 211 receives the verification result of the area name from the permanent area 157.

In step S297, the storage data factory 211 creates the data set 153 by specifying the data set name, storage data drawing 155, and the permanent area 157. In step S298, the storage data factory 211 obtains the data set 153.

In step S299, the storage data factory 211 sends a data set registration request to the data management IF 152 by specifying the data set 153. In step S300, the data management ID 152 performs a data set registering operation.

As described above, in a multifunctional production according to the embodiment of the present invention, the application logic 13 can send a request to create the data set 153.

### (Data Set Deletion)

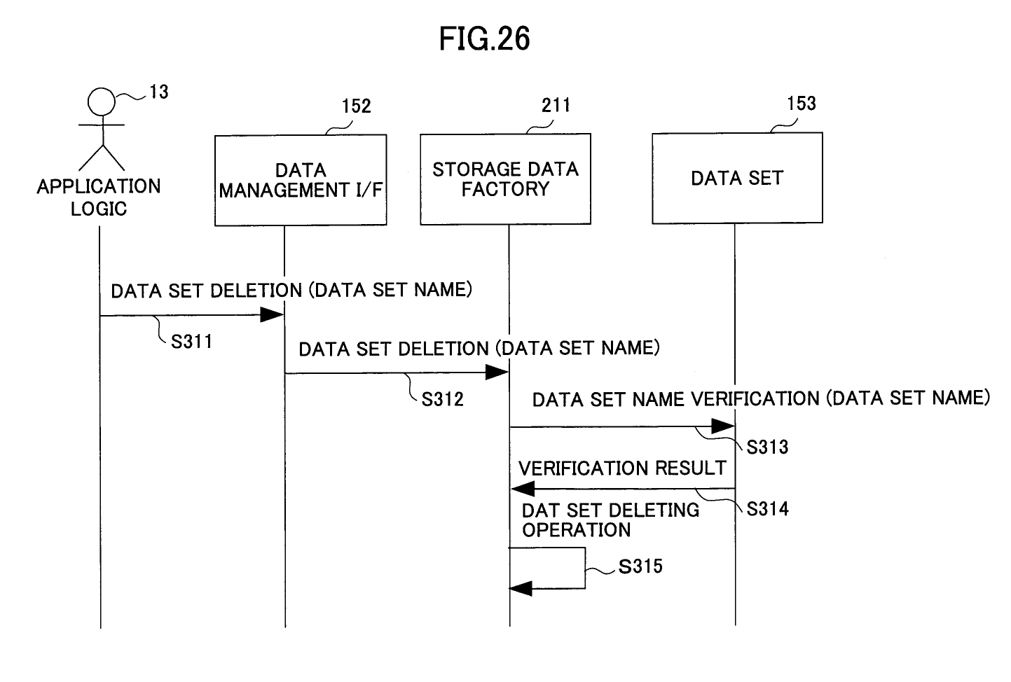

FIG. 26 is a sequence diagram showing an exemplary process of data set deletion. In step S311, the application logic 13 sends a data set deletion request to the data management IF 152 by specifying the data set name.

In step S312, the data management IF 152 sends the data set deletion request to the storage data factory 211 by specifying the data set name. In step S313, the storage data factory 211 sends a data set name verification request to the data set 153 by specifying the data set name.

In step S314, the storage data factory 211 receives the verification result of the data set name from the data set 153. In step S315, the storage data factory 211 performs the data set deleting operation.

As described above, in a multifunctional production according to the embodiment of the present invention, the application logic 13 can send a request to delete the data set 153.

### (Data Conversion)

As is described below, the data conversion is a collective term of the conversion from generic data to storage data, from generic data to-extension data, from storage data to generic data, from extension data to generic data, from generic data to persistent data, and from persistent data to generic data.

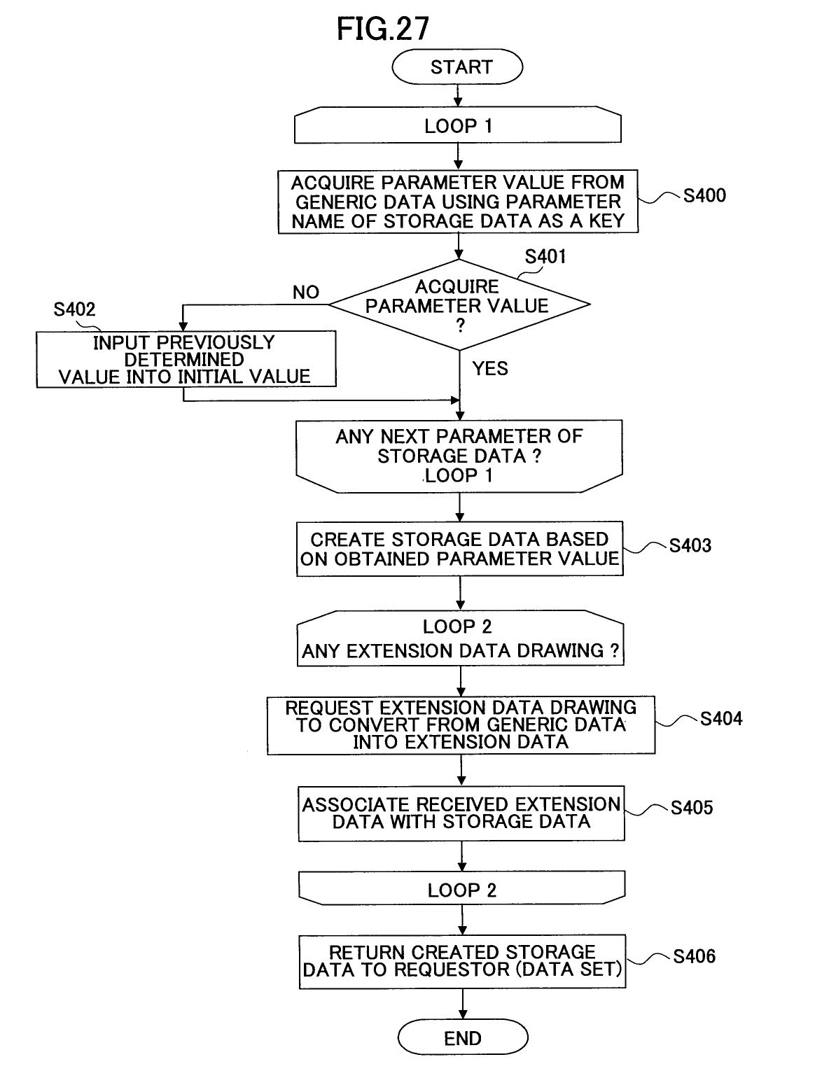

FIG. 27 is a flowchart showing an exemplary process of the data conversion from generic data to storage data. The process shown in the flowchart of FIG. 27 is performed by the above-mentioned storage data drawing 155.

In step S400, the storage data drawing 155 obtains a parameter value from generic data using the parameter name of the storage data as a key. In step S401, the storage data drawing 155 determines whether the parameter value is obtained. When the parameter is obtained, the process goes back to step S400 and the storage data drawing 155 performs the process for the next parameter of the storage data.

When no parameter value is obtained, the process goes to step S402 and the storage data drawing 155 inputs a previously determined initial value into the parameter value, and then the process goes back to step S400 to process for the next parameter of the storage data. The process of steps S400 through S402 is repeated until no next parameter of the storage data is left.

When no next parameter of the storage data is left, the process goes to step S403 and the storage data drawing 155 creates the storage data based on the obtained parameter value. When an extension data drawing 212 exists, the process goes to step S404.

In step S404, the storage data drawing 155 sends a data conversion request to the extension data drawing 212 to convert from generic data to extension data. A detailed process to convert from generic data to extension data is described below. In step S405, the storage data drawing 155 associates the extension data received from the extension data drawing 212 with the storage data.

After the storage data drawing 155 associates the extension data received from the extension data drawing 212 with the storage data, the process goes to step S406. When there is no extension data drawing 212, the process goes to step S406 from S403. In step S406, the storage data drawing 155 returns the created storage data to the requester (data set 153).

According to the process shown in the flowchart of FIG. 27, the storage data drawing 155 can convert from generic data to storage data.

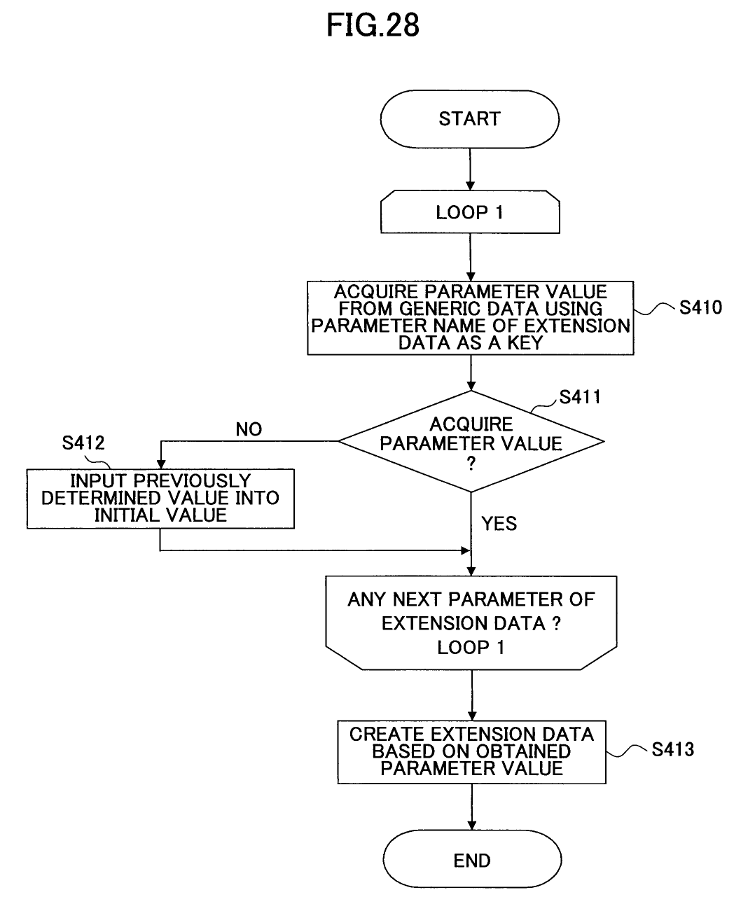

FIG. 28 is a flowchart showing an exemplary process of data conversion from generic data to extension data. The process shown in the flowchart of FIG. 28 is performed by the above-mentioned extension data drawing 212.

In step S410, the extension data drawing 212 obtains a parameter value from the generic data using a parameter name of the extension data as a key. In step S411, the extension data drawing 212 determines whether the parameter value is obtained. When the parameter value is obtained, the process goes back to step S410 and the extension data drawing 212 performs the process for the next parameter of the extension data.

When no parameter value is obtained, the process goes to step S412 and the extension data drawing 212 inputs the previously determined initial value into the parameter value, and the process goes back to step S410 to process the next parameter of the extension data. The process of steps S410 through S412 is repeated until no next parameter of the extension data is left. When no next parameter of the extension data is left, the process goes to step S413 and the extension data drawing 212 creates extension data based on the obtained parameter value.

According to the process shown in the flowchart of FIG. 28, the extension data drawing 212 can convert from generic data to extension data.

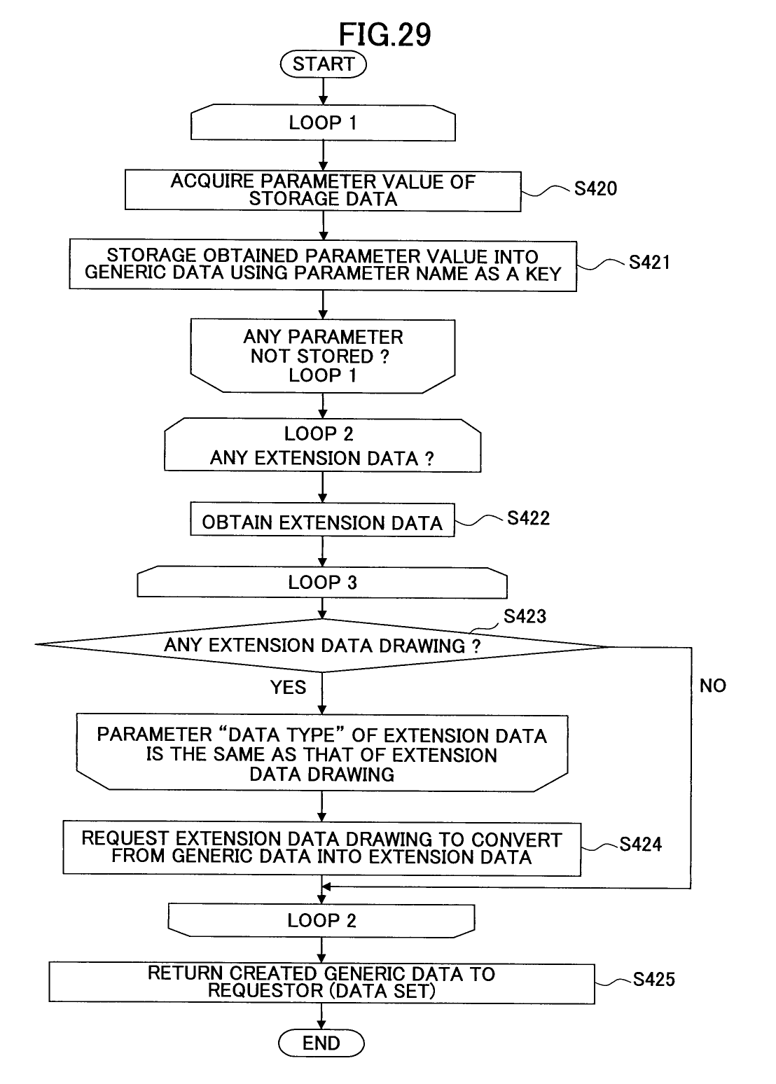

FIG. 29 is a flowchart showing an exemplary process of data conversion from storage data to generic data. The process shown in the flowchart of FIG. 29 is performed by the above-mentioned storage data drawing 155.

In step S420, the storage data drawing 155 obtains a parameter value of the storage data. In step S421, the storage data drawing 155 stores the parameter values of the storage data in the generic data using the parameter name as a key. The storage data drawing 155 repeats the process of steps S420 and S421 until no parameter not stored is left.

When there is any extension data, the process goes to step S422, and the storage data drawing 155 obtains the extension data. In step S423, the storage data drawing 155 determines whether any extension data drawing 212 exists. When any extension data drawing 212 exists, the storage data drawing 155 determines whether the parameter “parameter type” of the extension data is the same as the parameter “parameter type” of the extension data drawing 212.

When the parameter “parameter type” of the extension data is determined to be the same as the parameter “parameter type” of the extension data drawing 212, the process goes to step S424 and the storage data drawing 155 sends a conversion request to the extension data drawing 212 to convert data from extension data to generic data. Then, the process goes back to step S422.

When it is determined that the parameter “parameter type” of the extension data is not the same as the parameter “parameter type” of the extension data drawing 212, the process goes back to step S423. When there is no extension data 212 (No at step S423), the process goes back to step S422. The storage data drawing 155 repeats the process in steps S422 through S424 until no extension data are left. When there are no extension data left, the process goes to step S425. In step S425, the storage data drawing 155 returns the created generic data to the requester (the data set 153).

According to the process shown in the flowchart of FIG. 29, the storage data drawing 155 can convert from storage data to generic data.

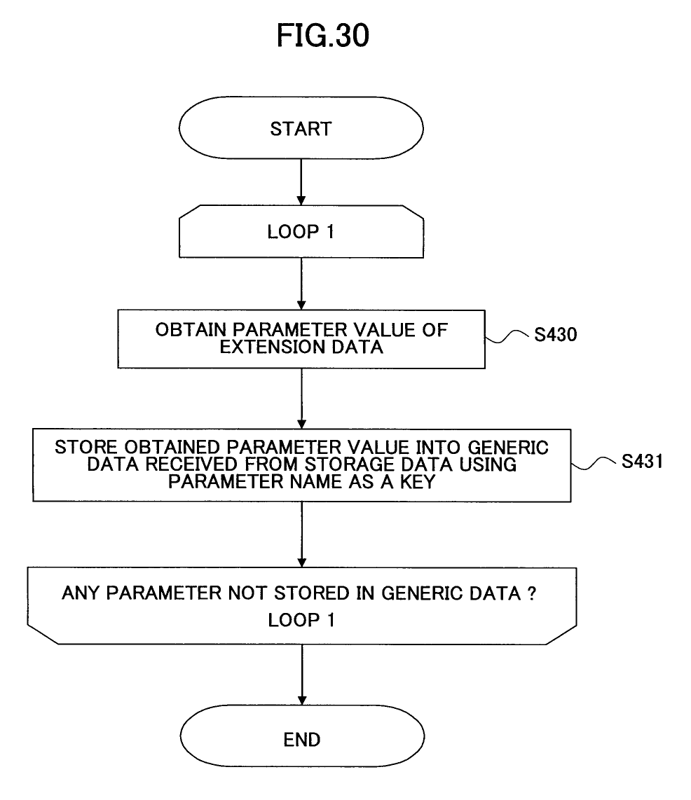

FIG. 30 is a flowchart showing an exemplary process of data conversion from extension data to generic data. The process shown in the flowchart of FIG. 30 is performed by the above-mentioned extension data drawing 212.

In step S430, the extension data drawing 212 obtains a parameter value of the extension data. In step S431, the extension data drawing 212 stores the parameter value of the extension data obtained in step S430 in the generic data received from the storage data drawing 155. The extension data drawing 212 repeats the process in steps S430 and S431 until no parameter not stored is left.

According to the process shown in the flowchart of FIG. 30, the extension data drawing 212 can convert from extension data to generic data.

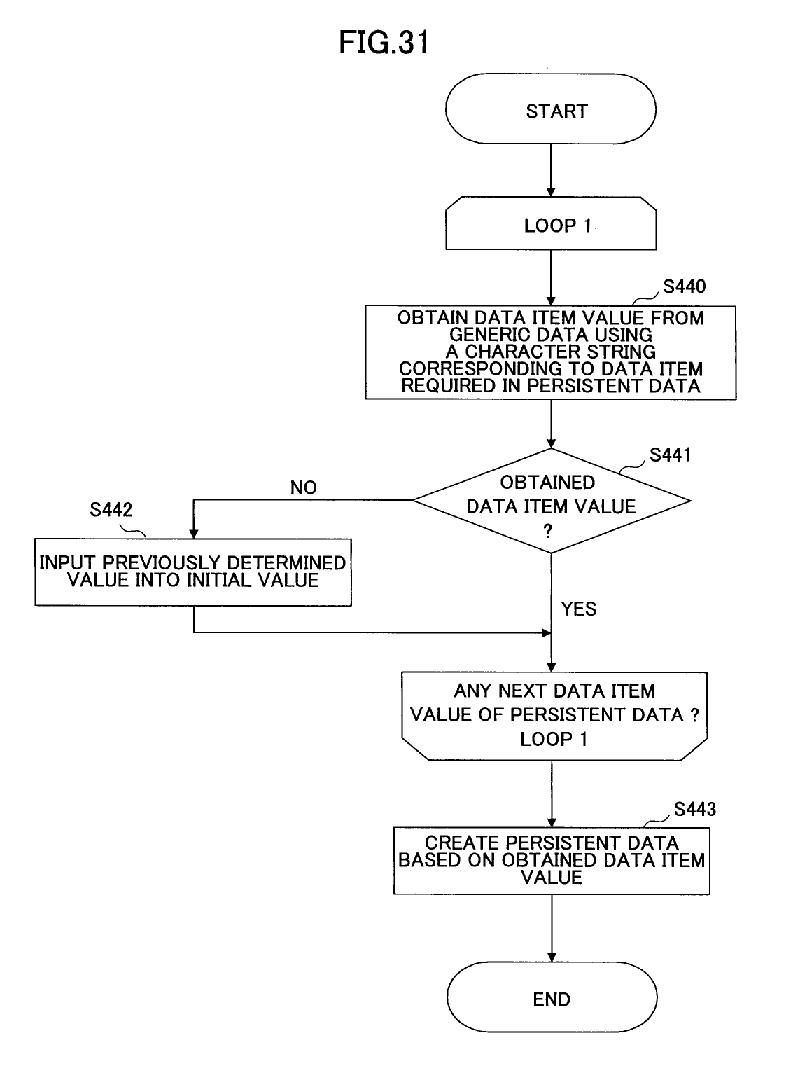

FIG. 31 is a flowchart showing an exemplary process of data conversion from generic data to persistent data. The process shown in the flowchart of FIG. 31 is performed by the above-mentioned storage format 158.

In step S440, the storage format 158 obtains a data item value from generic data using a character string corresponding to the data item required in persistent data as a key. In step S441, the storage format 158 determines whether the data item value is obtained. When the data item value is obtained, the process goes back to step S440 and the storage format 158 performs the process for the next data item of the data item required in the persistent data.

When no data item value is obtained, the process goes to step S442 and the storage format 158 inputs the previously determined initial value into the data item value. Then the process goes back to step S440 to perform the process for the next data item of the data item required in the persistent data. The process of steps S440 through S442 is repeated until no next data item of the data item required in the persistent data is left. When no next data item of the data item required in the persistent data is left, the process goes to step S443 and the storage format 158 creates the persistent data based on the obtained data item value.

According to the process shown in the flowchart of FIG. 31, the storage format 158 can convert from generic data to persistent data.

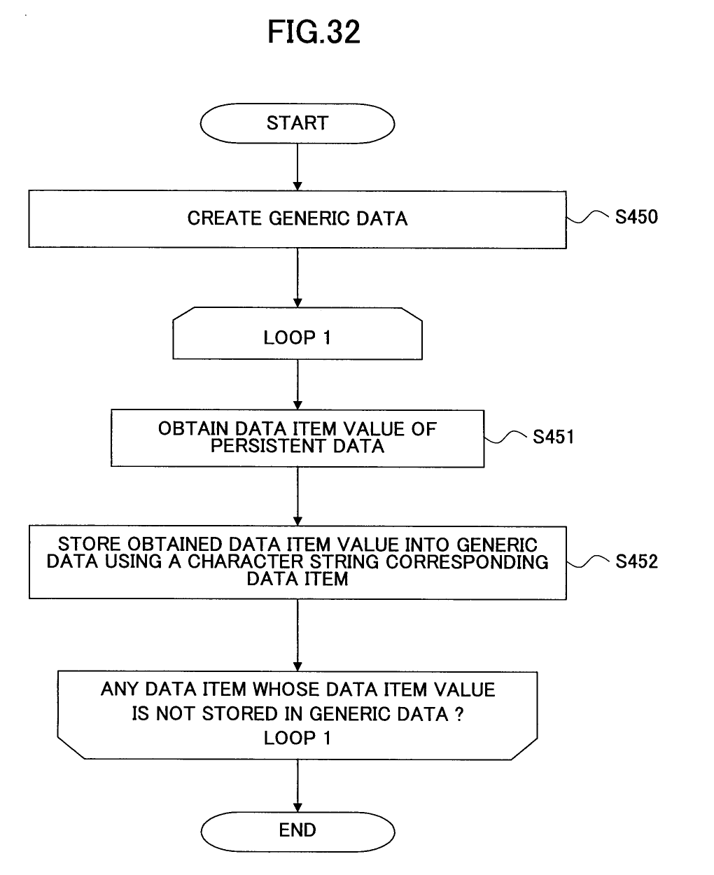

FIG. 32 is a flowchart showing an exemplary process of data conversion from persistent data to generic data. The process shown in the flowchart of FIG. 32 is performed by the above-mentioned storage format 158.

In step S450, the storage format 158 creates generic data. In step S451, the storage format 158 obtains the data item value of the persistent data. In step S452, the storage format 158 stores the data item value obtained in step S451 into the generic data created in step S450 using a character string corresponding to the data item as a key. The storage format 158 repeats the process of steps S451 and S452 until no data item having no data item value is left in the generic data.

According to the process shown in the flowchart of FIG. 32, the storage format 158 can convert from persistent data to generic data.

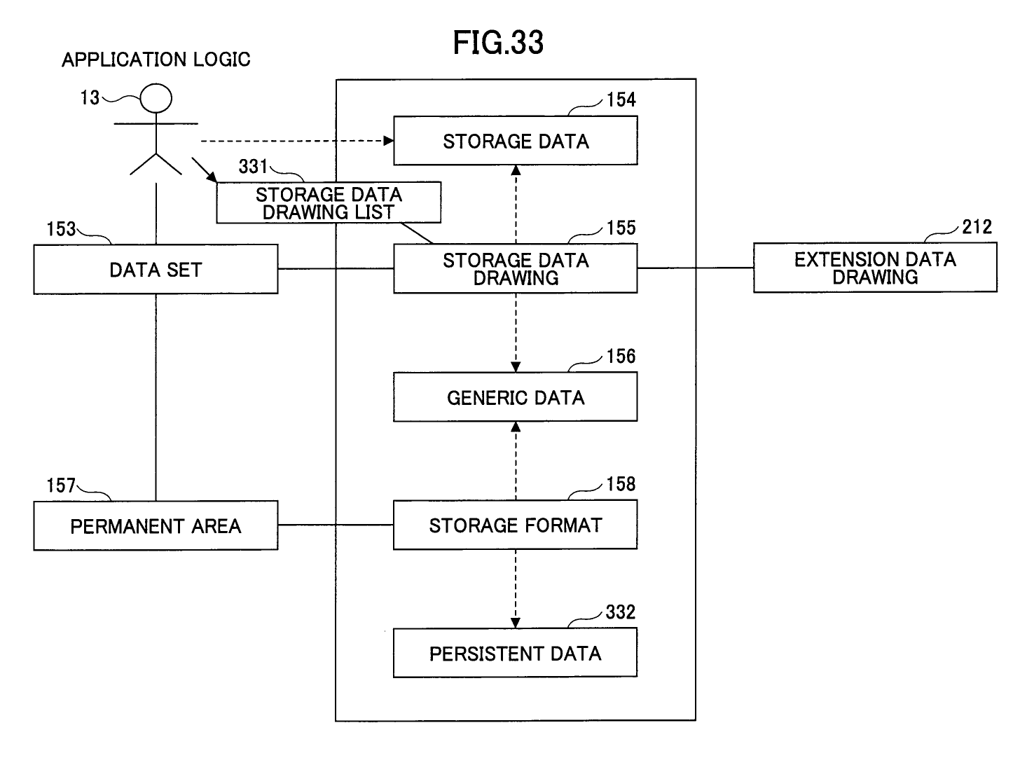

FIG. 33 is a block diagram showing the status of data conversions. The block diagram of FIG. 33 shows an example where the storage data drawing 155 and the storage format 158 convert data of storage data, generic data and persistent data.

More specifically, the storage data drawing 155 performs mutual data conversion between storage data 154 and generic data 156. Further, the storage data drawing 155 sends a request to the extension data drawing 212 to perform mutual data conversion between extension data and generic data 156. The storage format 158 performs mutual data conversion between generic data 156 and persistent data 159.

The application logic 13 can use the storage data 154. The permanent unit 151 can register persistent data 332. The application logic 13 can check the list of storage data drawings registered by the storage data drawing list 311.

The data set 153 memorizes the permanent area 157 corresponding to the data. The permanent area 157 memorizes the access method (process of data access) to the permanent unit 151.

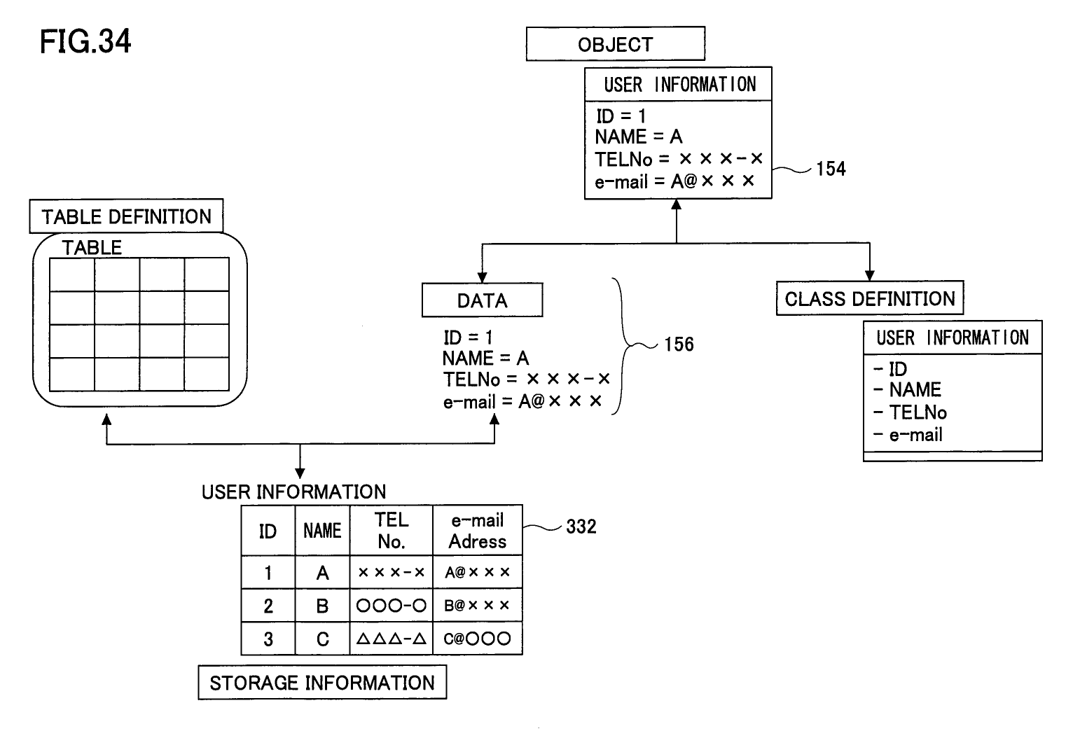

FIG. 34 is a schematic diagram showing a status of data conversion. FIG. 34 shows an example of the DBMS.

The storage data drawing 155 converts the storage data 154 capable of being used by the application logic 13 into the generic data 156 composed of the data item name and the data item value. The storage data drawing 155 using class definition converts the generic data 156 into the storage data 154.

The storage format 158 using table definitions converts the persistent data 332 capable of being registered in permanent unit 151 into the generic data 156. The storage format 158 converts the persistent data 332 into the generic data 156.

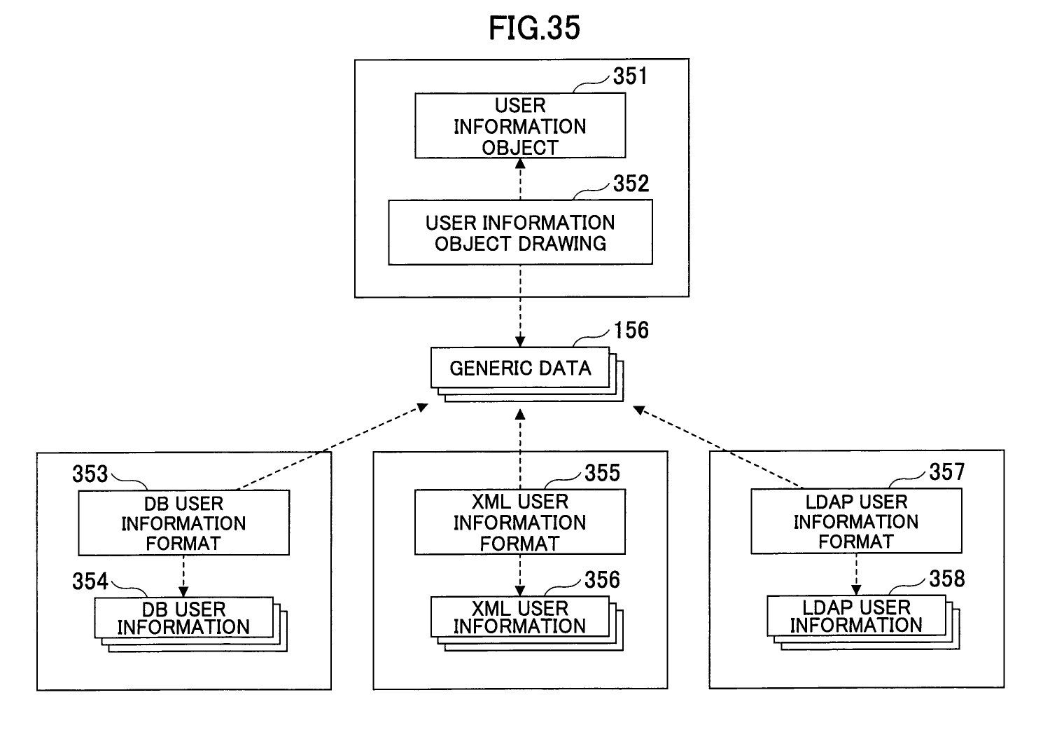

FIG. 35 is an object diagram showing a status of data conversion. The user information object 351 and the user information object drawing 352 are handled as a bundle, and each bundle can be attached and detached as a unit. Similarly, the DB user information format 353 and the DB user information 354 are to be handled as a bundle; the XML user information format 355 and the XML user information 356 are to be handled as a bundle; and the LDAP user information format 357 and the LDAP user information 358 are to be handled as a bundle.

The user information object 351 corresponds to the storage data 154. The user information object drawing 352 corresponds to the storage data drawing 155. The DB user information format 353 corresponds to the storage format 158. The DB user information 354 corresponds to the persistent data 332. The XML user information format 355 corresponds to the storage format 158. The XML user information 356 corresponds to the persistent data 332. The LDAP user information format 357 corresponds to the storage format 158. The LDAP user information 358 corresponds to the persistent data 332.

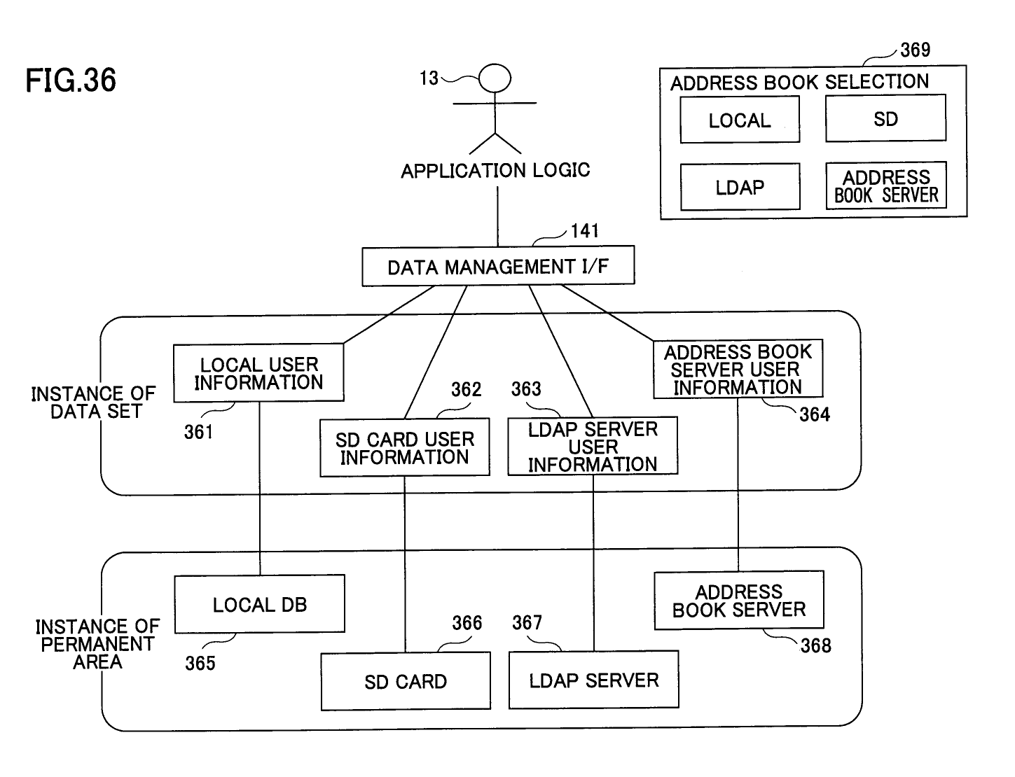

FIG. 36 is an object diagram showing a relationship between the application logic and the storage data type. The object diagram of FIG. 36 shows a case where the application logic 13 recognizes the difference among permanent units 151 as a user on the operations panel of the multifunctional product by taking the user information, for example. For example, the address book selection menu 369 is displayed on the operations panel.

The local user information 361, the SD card user information 362, the LDAP server user information 363, and the address book server user information 364 refer to the instances of the data set 143. The local DB 365, the SD card 366, the LDAP server 367, and the address book server 368 refer to the instances of the permanent area 147.

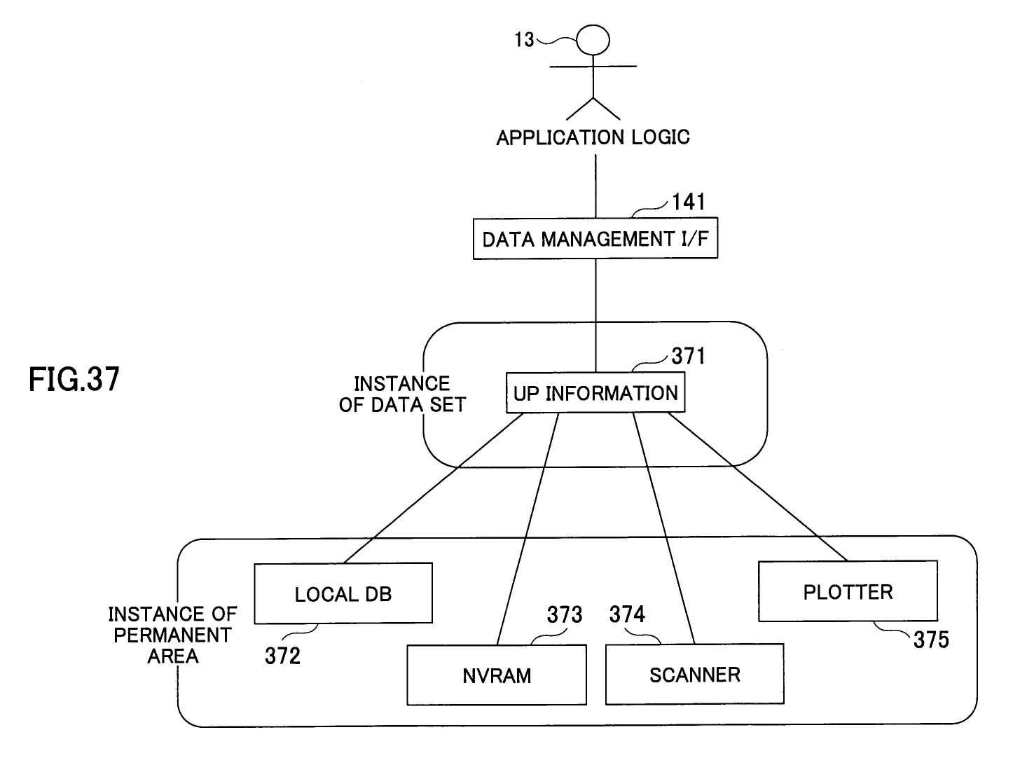

In a case where the application logic 13 does not recognize the difference of the permanent units 151, an object diagram is provided as shown in FIG. 37. In FIG. 37 is an object diagram showing a relationship between the application logic and the storage data type. The UP information 371 refers to an instance of the data set. The local DB 372, the NVRAM 373, the scanner 374, and the plotter 375 refer to the instances of the permanent area 147.

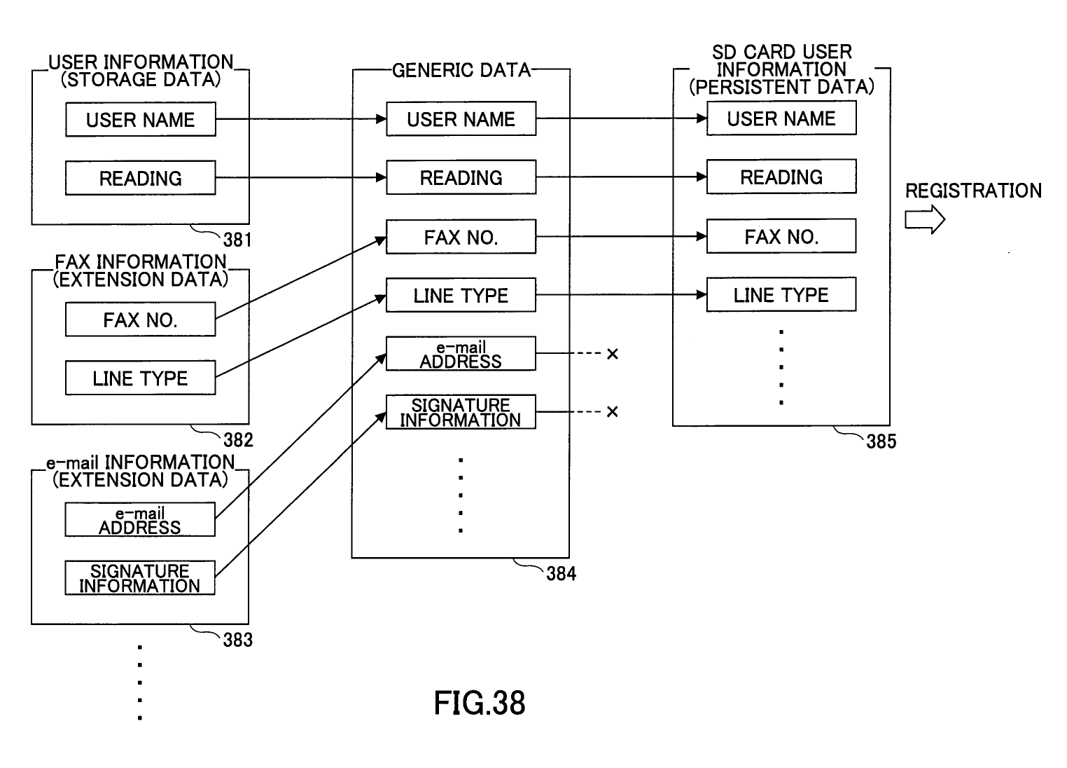

FIG. 38 is a schematic diagram of data registration. FIG. 38 provides an image showing the data registration of the user information as an example. In FIG. 38, it is assumed that the SD card does not have the data items, for example, storing e-mail information.

In FIG. 38, the data of user information 381 of the storage data, the FAX information 382 of the extension information, and the e-mail information 383 of the extension information are converted into the generic data 384. When the generic data 384 are converted into the persistent data of the SD card user information, since there is no data item for storing the e-mail information in the SD card, the SD card user information 385 ignores the data items “e-mail address” and “signature information” belonging to the e-mail information.

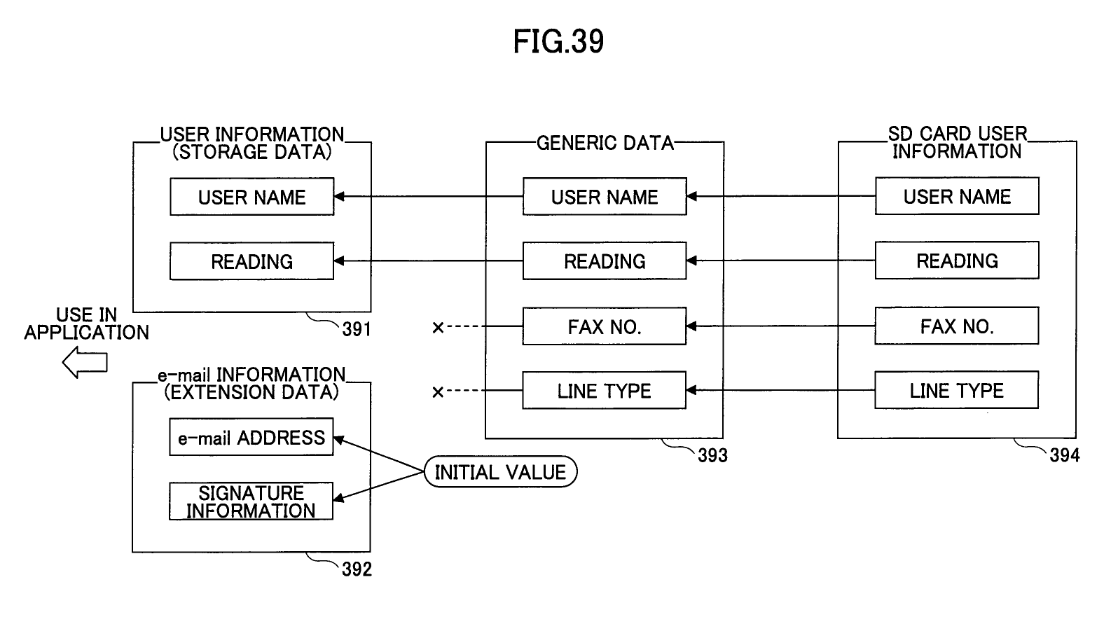

FIG. 39 is a schematic diagram of data acquisition. FIG. 39 shows an example of the data acquisition of the user information. In FIG. 39, the multifunctional product does not have the FAX function and accordingly no FAX information exists in the multifunctional product.

In FIG. 39, the data of SD card user information 394 are converted into the generic data 393. When the generic data 393 are converted into the storage data or the extension data, the data of the data items “user name” and “reading” belonging to the user information 391 are converted into the data of the user information of the storage data.

In contrast, when the generic data 393 are converted into the storage data or the extension data, since the multifunction product does not have the FAX function, the data of the data items “FAX No.” and “Line type” belonging to the FAX information are discarded.

Further, since the e-mail information is not included in the SD card user information 394, the previously determined initial values are input into the e-mail information 392 of the extension data so as to be acquired by the application logic 13.

The present invention is not limited to the above-mentioned embodiments, and variations and modifications may be made without departing from the scope of the present invention. The data managing unit, the data set unit, and the data set managing unit described in claims of the present invention correspond to the data management component 73, the data set 76, and the data set management 75, respectively.

The present application is based on and claims the benefit of priority of Japanese patent application No. 2006-279106, filed on Oct. 12, 2006, the entire contents of which are hereby incorporated by reference.

What is claimed is:

1. An information processing apparatus comprising:
one or more storage units storing data used by software managed by the information processing apparatus; and
a data managing unit, when a program capable of providing an additional function to the software is provided, receiving knowledge/information of a data item required to execute the additional function from the program and extending the data item of the data stored in the storage unit based on the knowledge/information.

2. The image processing apparatus according to claim 1, wherein the data managing unit includes:
one or more data set units each managing data stored in the one or more storage units; and
a data set managing unit collectively managing the one or more data set units, selecting the storage unit based on the knowledge/information, and causing the data set unit managing the storage unit to extend the data item.

3. The image processing apparatus according to claim 2, wherein when the data set unit managing the storage unit based on the knowledge/information does not exist, the data set managing unit creates a new data set unit managing the data stored in the storage unit and causes the created data set unit to extend the data item.

4. The image processing apparatus according to claim 2, wherein the data set unit includes:
a first data converting unit mutually converting between data usable by the software and generic data; and
a second data converting unit mutually converting between data capable of being stored in the storage unit and the generic data.

5. The image processing apparatus according to claim 4, wherein the data set unit includes:
a first information providing unit providing information so that the first data converting unit can mutually convert between the data usable by the software and the generic data.

6. The image processing apparatus according to claim 4, wherein the data set unit includes:
a second information providing unit providing information so that the second data converting unit can mutually convert between the data capable of being stored in the storage unit and the generic data.

7. The image processing apparatus according to claim 5, wherein the generic data are the sets of the data item name and the data item value.

8. The information processing apparatus according to claim 6, wherein the data capable of being stored in the storage unit are expressed in the data format stored in the storage unit.

9. The information processing apparatus according to claim 6, wherein the second information providing unit provides information for hiding a method to access to the storage unit.

10. The information processing apparatus according to claim 1, wherein the additional program is a plug-in component.

11. A data management method employed in an image processing apparatus including one or more storage units storing data used by software managed by the information processing apparatus, the method comprising:
a receiving step of, when a program capable of providing an additional function to the software is provided, receiving knowledge knowledge/information of a data item required to execute the function from the program; and
an extending step of extending the data item of the data stored in the storage unit based on the knowledge/information.

12. A data management program executed in an information processing apparatus including:
one or more storage units storing data used by software managed by the information processing apparatus;
a storage device including one or more types of storage media storing data of the one or more storage units; and
a processing unit, wherein:
the data management program causes the processing unit to work as a data managing unit, when a program capable of providing an additional function to the software is provided, receiving knowledge/information of a data item required to execute the function from the program and extending the data item of the data stored in the storage unit based on the knowledge/information.

13. The data management program according to claim 12, wherein the data managing unit includes:
one or more data set units each managing data stored in the one or more storage units; and
a data set managing unit collectively managing the one or more data set units, selecting the storage unit based on the knowledge/information, and causing the data set unit managing the storage unit to extend the data item.

14. The data management program according to claim 13, wherein when the data set unit managing the storage unit based on the knowledge/information does not exist, the data set managing unit creates a new data set unit managing the data stored in the storage unit and causes the created data set unit to extend the data item.

15. The data management program according to claim 13, wherein the data set unit includes:
a first data converting unit mutually converting between data usable by the software and generic data; and
a second data converting unit mutually converting between data capable of being stored in the storage unit and the generic data.

16. The data management program according to claim 15, wherein the data set unit includes:
a first information providing unit providing information so that the first data converting unit can mutually convert between the data usable by the software and the generic data.

17. The data management program according to claim 15, wherein the data set unit includes:
a second information providing unit providing information so that the second data converting unit can mutually convert between the data capable of being stored in the storage unit and the generic data.

18. The data management program according to claim 16, wherein the generic data are the sets of the data item name and the data item value.

19. The data management program according to claim 17, wherein the data capable of being stored in the storage unit are expressed in the data format stored in the storage unit.

20. The data management program according to claim 17, wherein the second information providing unit provides information for hiding a method to access to the storage unit.
